(19) United States
(12) Patent Application Publication
(10) Pub. No.: US 2025/0039811 A1
(43) Pub. Date: Jan. 30, 2025

(54) TIMING ADVANCE COMMAND FOR DOWNLINK CONTROL INFORMATION FOR TRANSMISSION RECEPTION POINT OPERATION

(71) Applicant: QUALCOMM Incorporated, San Diego, CA (US)

(72) Inventors: Fang YUAN, Beijing (CN); Yan ZHOU, San Diego, CA (US); Mostafa KHOSHNEVISAN, San Diego, CA (US); Shaozhen GUO, Beijing (CN); Xiaoxia ZHANG, San Diego, CA (US); Tao LUO, San Diego, CA (US); Peter GAAL, San Diego, CA (US); Junyi LI, Greentown, PA (US)

(21) Appl. No.: 18/716,890

(22) PCT Filed: Feb. 10, 2022
(86) PCT No.: PCT/CN2022/075755

§ 371 Date: Jun. 5, 2024

(51) Int. Cl. H04W 56/00; H04W 72/231; H04W 76/15; H04W 80/02

(52) U.S. Cl. CPC H04W 56/0045; H04W 72/231; H04W 76/15; H04W 80/02

(57) ABSTRACT

Methods, systems, and devices for wireless communication at a user equipment (UE) are described. A UE may establish communication with a set of transmission reception points including a first transmission reception point and a second transmission reception point. The UE may receive a single control message including one or more respective timing advance indications for uplink channel transmissions to one or more respective transmission reception points. In some examples, each timing advance indication may identify a respective transmission reception point using a respective timing advance value. The UE may determine a first timing advance value for the uplink channel transmissions based on the one or more respective timing advance indications identifying a respective transmission reception point. The UE may then transmit, to the first transmission reception point, an uplink channel transmission over an uplink channel using the first timing advance value determined for the first transmission reception point.

### CROSS REFERENCE

The present Application is a 371 national stage filing of International PCT Application No. PCT/CN2022/075755 by YUAN et al. entitled “TIMING ADVANCE COMMAND FOR DOWNLINK CONTROL INFORMATION FOR TRANSMISSION RECEPTION POINT OPERATION,” filed Feb. 10, 2022, which is assigned to the assignee hereof, and which is expressly incorporated by reference in its entirety herein.

### FIELD OF TECHNOLOGY

The following relates to wireless communication at a user equipment (UE), including a timing advance command for downlink control information for transmission reception point operation.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM).

A wireless multiple-access communications system may include one or more base stations or one or more network access nodes, each simultaneously supporting communication for multiple communication devices, which may be otherwise known as user equipment (UE).

### SUMMARY

The described techniques relate to improved methods, systems, devices, and apparatuses that support a timing advance command for downlink control information for transmission reception point operation. Generally, the techniques described herein provide for configuring different timing advance values for different uplink channels or different transmission reception points. A user equipment (UE) may receive a control message (e.g. medium access control (MAC) control element (CE)) including one or more timing advance indicators corresponding to different transmission reception points. A control message, such as each control message in some examples, may include a timing advance group identifier that maps to a respective transmission reception point. Additionally or alternatively, the control message may include a timing advance command associated with the transmission reception point. Additionally or alternatively, the control message may include the transmission reception point identifier. The UE may determine a timing advance value for at last some if not each transmission reception point based on the timing advance command included in the control message. The UE may use a respective timing advance value to communicate with a respective transmission reception point.

A method for wireless communication at a user equipment (UE) is described. The method may include establishing communication with a set of multiple transmission reception points including a first transmission reception point and a second transmission reception point, receiving a single control message including one or more respective timing advance indications for uplink channel transmissions to one or more respective transmission reception points of the set of multiple transmission reception points, each timing advance indication of the one or more respective timing advance indications identifying a respective transmission reception point of the one or more respective transmission reception points that is associated with the uplink channel transmissions using a respective timing advance value, determining a first timing advance value for the uplink channel transmissions to the first transmission reception point of the one or more respective transmission reception points based on the one or more respective timing advance indications identifying the respective transmission reception point of the one or more respective transmission reception points, and transmitting, to the first transmission reception point of the one or more respective transmission reception points, an uplink channel transmission over an uplink channel using the first timing advance value determined for the first transmission reception point.

An apparatus for wireless communication at a UE is described. The apparatus may include a processor, memory coupled with the processor, and instructions stored in the memory. The instructions may be executable by the processor to cause the apparatus to establish communication with a set of multiple transmission reception points including a first transmission reception point and a second transmission reception point, receive a single control message including one or more respective timing advance indications for uplink channel transmissions to one or more respective transmission reception points of the set of multiple transmission reception points, each timing advance indication of the one or more respective timing advance indications identifying a respective transmission reception point of the one or more respective transmission reception points that is associated with the uplink channel transmissions using a respective timing advance value, determine a first timing advance value for the uplink channel transmissions to the first transmission reception point of the one or more respective transmission reception points based on the one or more respective timing advance indications identifying the respective transmission reception point of the one or more respective transmission reception points, and transmit, to the first transmission reception point of the one or more respective transmission reception points, an uplink channel transmission over an uplink channel using the first timing advance value determined for the first transmission reception point.

Another apparatus for wireless communication at a UE is described. The apparatus may include means for establishing communication with a set of multiple transmission reception points including a first transmission reception point and a second transmission reception point, means for receiving a single control message including one or more respective timing advance indications for uplink channel transmissions to one or more respective transmission reception points of the set of multiple transmission reception points, each timing advance indication of the one or more respective timing advance indications identifying a respective transmission reception point of the one or more respective transmission reception points that is associated with the uplink channel transmissions using a respective timing advance value, means for determining a first timing advance value for the uplink channel transmissions to the first transmission reception point of the one or more respective transmission reception points based on the one or more respective timing advance indications identifying the respective transmission reception point of the one or more respective transmission reception points, and means for transmitting, to the first transmission reception point of the one or more respective transmission reception points, an uplink channel transmission over an uplink channel using the first timing advance value determined for the first transmission reception point.

A non-transitory computer-readable medium storing code for wireless communication at a UE is described. The code may include instructions executable by a processor to establish communication with a set of multiple transmission reception points including a first transmission reception point and a second transmission reception point, receive a single control message including one or more respective timing advance indications for uplink channel transmissions to one or more respective transmission reception points of the set of multiple transmission reception points, each timing advance indication of the one or more respective timing advance indications identifying a respective transmission reception point of the one or more respective transmission reception points that is associated with the uplink channel transmissions using a respective timing advance value, determine a first timing advance value for the uplink channel transmissions to the first transmission reception point of the one or more respective transmission reception points based on the one or more respective timing advance indications identifying the respective transmission reception point of the one or more respective transmission reception points, and transmit, to the first transmission reception point of the one or more respective transmission reception points, an uplink channel transmission over an uplink channel using the first timing advance value determined for the first transmission reception point.

In some examples of the method, apparatuses, and non-transitory computer-readable medium described herein, receiving the single control message including the one or more respective timing advance indications may include operations, features, means, or instructions for receiving a first control message including a first timing advance command indication corresponding to the first transmission reception point of the one or more respective transmission reception points and receiving a second control message including a second timing advance command indication corresponding to the second transmission reception point of the one or more respective transmission reception points.

Some examples of the method, apparatuses, and non-transitory computer-readable medium described herein may further include operations, features, means, or instructions for determining the first transmission reception point based on a first timing advance group identifier included in the first control message and determining the second transmission reception point based on a second timing advance group identifier included in the second control message, where transmitting the uplink channel transmission may be based on determining the first transmission reception point and the second transmission reception point.

Some examples of the method, apparatuses, and non-transitory computer-readable medium described herein may further include operations, features, means, or instructions for receiving a control signaling indicating a mapping between a set of multiple timing advance group identifiers and the set of multiple transmission reception points, where the set of multiple timing advance group identifiers includes the first timing advance group identifier and the second timing advance group identifier, and where transmitting the uplink channel transmission may be based on receiving the control signaling indicating the mapping.

Some examples of the method, apparatuses, and non-transitory computer-readable medium described herein may further include operations, features, means, or instructions for determining the first transmission reception point based on a first transmission reception point identifier included in the first control message and determining the second transmission reception point based on a second transmission reception point identifier included in the second control message, where transmitting the uplink channel transmission may be based on determining the first transmission reception point and the second transmission reception point.

Some examples of the method, apparatuses, and non-transitory computer-readable medium described herein may further include operations, features, means, or instructions for determining that the first timing advance command indication and the second timing advance command indication may be associated with a common timing advance group identifier, where transmitting the uplink channel transmission may be based on determining that the first timing advance command indication and the second timing advance command indication may be associated with the common timing advance group identifier.

In some examples of the method, apparatuses, and non-transitory computer-readable medium described herein, receiving the single control message including the one or more respective timing advance indications may include operations, features, means, or instructions for receiving the single control message including the first timing advance value corresponding to the first transmission reception point and a second respective timing advance value corresponding to the second transmission reception point.

Some examples of the method, apparatuses, and non-transitory computer-readable medium described herein may further include operations, features, means, or instructions for receiving a second control message including a timing advance group identifier and a reference timing advance value associated with the timing advance group identifier, where determining the first timing advance value for the uplink channel transmissions to the first transmission reception point may be based on receiving the second control message.

Some examples of the method, apparatuses, and non-transitory computer-readable medium described herein may further include operations, features, means, or instructions for refraining from accumulating the one or more respective timing advance indications, where determining the first timing advance value for the uplink channel transmissions to the first transmission reception point may be based on refraining from accumulating the one or more respective timing advance indications.

Some examples of the method, apparatuses, and non-transitory computer-readable medium described herein may further include operations, features, means, or instructions for accumulating the one or more respective timing advance indications, where determining the first timing advance value for the uplink channel transmissions to the first transmission reception point may be based on accumulating the one or more respective timing advance indications. In some examples of the method, apparatuses, and non-transitory computer-readable medium described herein, the single control message includes a medium access control layer control element.

A method for wireless communication at a network entity is described. The method may include establishing communication with a UE, transmitting a single control message including one or more respective timing advance indications for uplink channel transmissions to one or more respective transmission reception points of a set of multiple transmission reception points including a first transmission reception point and a second transmission reception point, each timing advance indication of the one or more respective timing advance indications identifying a respective transmission reception point of the one or more respective transmission reception points that is associated with the uplink channel transmissions using a respective timing advance value, determining a first timing advance value for the uplink channel transmissions to the first transmission reception point of the one or more respective transmission reception points based on the one or more respective timing advance indications identifying the respective transmission reception point of the one or more respective transmission reception points, and receiving an uplink channel transmission over an uplink channel using the first timing advance value determined for the first transmission reception point.

An apparatus for wireless communication at a network entity is described. The apparatus may include a processor, memory coupled with the processor, and instructions stored in the memory. The instructions may be executable by the processor to cause the apparatus to establish communication with a UE, transmit a single control message including one or more respective timing advance indications for uplink channel transmissions to one or more respective transmission reception points of a set of multiple transmission reception points including a first transmission reception point and a second transmission reception point, each timing advance indication of the one or more respective timing advance indications identifying a respective transmission reception point of the one or more respective transmission reception points that is associated with the uplink channel transmissions using a respective timing advance value, determine a first timing advance value for the uplink channel transmissions to the first transmission reception point of the one or more respective transmission reception points based on the one or more respective timing advance indications identifying the respective transmission reception point of the one or more respective transmission reception points, and receive an uplink channel transmission over an uplink channel using the first timing advance value determined for the first transmission reception point.

Another apparatus for wireless communication at a network entity is described. The apparatus may include means for establishing communication with a UE, means for transmitting a single control message including one or more respective timing advance indications for uplink channel transmissions to one or more respective transmission reception points of a set of multiple transmission reception points including a first transmission reception point and a second transmission reception point, each timing advance indication of the one or more respective timing advance indications identifying a respective transmission reception point of the one or more respective transmission reception points that is associated with the uplink channel transmissions using a respective timing advance value, means for determining a first timing advance value for the uplink channel transmissions to the first transmission reception point of the one or more respective transmission reception points based on the one or more respective timing advance indications identifying the respective transmission reception point of the one or more respective transmission reception points, and means for receiving an uplink channel transmission over an uplink channel using the first timing advance value determined for the first transmission reception point.

A non-transitory computer-readable medium storing code for wireless communication at a network entity is described. The code may include instructions executable by a processor to establish communication with a UE, transmit a single control message including one or more respective timing advance indications for uplink channel transmissions to one or more respective transmission reception points of a set of multiple transmission reception points including a first transmission reception point and a second transmission reception point, each timing advance indication of the one or more respective timing advance indications identifying a respective transmission reception point of the one or more respective transmission reception points that is associated with the uplink channel transmissions using a respective timing advance value, determine a first timing advance value for the uplink channel transmissions to the first transmission reception point of the one or more respective transmission reception points based on the one or more respective timing advance indications identifying the respective transmission reception point of the one or more respective transmission reception points, and receive an uplink channel transmission over an uplink channel using the first timing advance value determined for the first transmission reception point.

In some examples of the method, apparatuses, and non-transitory computer-readable medium described herein, transmitting the single control message including the one or more respective timing advance indications may include operations, features, means, or instructions for transmitting a second control message including a timing advance command indication corresponding to the first transmission reception point of the one or more respective transmission reception points.

In some examples of the method, apparatuses, and non-transitory computer-readable medium described herein, transmitting the second control message may include operations, features, means, or instructions for including a timing advance group identifier indicating the first transmission reception point in the second control message, where receiving the uplink channel transmission may be based on including the timing advance group identifier in the second control message.

Some examples of the method, apparatuses, and non-transitory computer-readable medium described herein may further include operations, features, means, or instructions for transmitting a control signaling indicating a mapping between a set of multiple timing advance group identifiers and the set of multiple transmission reception points, where the set of multiple timing advance group identifiers includes the timing advance group identifier, and where receiving the uplink channel transmission may be based on transmitting the control signaling indicating the mapping.

In some examples of the method, apparatuses, and non-transitory computer-readable medium described herein, transmitting the second control message may include operations, features, means, or instructions for including a transmission reception point identifier indicating the first transmission reception point in the second control message, where receiving the uplink channel transmission may be based on including the transmission reception point identifier in the second control message.

In some examples of the method, apparatuses, and non-transitory computer-readable medium described herein, transmitting the single control message including the one or more respective timing advance indications may include operations, features, means, or instructions for transmitting the single control message including the first timing advance value corresponding to the first transmission reception point and a second respective timing advance value corresponding to the second transmission reception point.

Some examples of the method, apparatuses, and non-transitory computer-readable medium described herein may further include operations, features, means, or instructions for transmitting a second control message including a timing advance group identifier and a reference timing advance value associated with the timing advance group identifier, where determining the first timing advance value for the uplink channel transmissions to the first transmission reception point may be based on transmitting the second control message.

### BRIEF DESCRIPTION OF THE DRAWINGS

FIG. 1 illustrates an example of a wireless communications system that supports timing advance command for downlink control information for transmission reception point operation in accordance with aspects of the present disclosure.

FIG. 2 illustrates an example of a wireless communications system that supports timing advance command for downlink control information for transmission reception point operation in accordance with aspects of the present disclosure.

FIGS. 3A, 3B, and 3C illustrate examples of a wireless communications system that supports timing advance command for downlink control information for transmission reception point operation in accordance with aspects of the present disclosure.

FIGS. 4A, 4B, and 4C illustrate examples of control messages that supports timing advance command for downlink control information for transmission reception point operation in accordance with aspects of the present disclosure.

FIG. 5 illustrates an example of a process flow that supports timing advance command for downlink control information for transmission reception point operation in accordance with aspects of the present disclosure.

FIGS. 6 and 7 show block diagrams of devices that support a timing advance command for downlink control information for transmission reception point operation in accordance with aspects of the present disclosure.

FIG. 8 shows a block diagram of a communications manager that supports a timing advance command for downlink control information for transmission reception point operation in accordance with aspects of the present disclosure.

FIG. 9 shows a diagram of a system including a device that supports a timing advance command for downlink control information for transmission reception point operation in accordance with aspects of the present disclosure.

FIGS. 10 and 11 show block diagrams of devices that support a timing advance command for downlink control information for transmission reception point operation in accordance with aspects of the present disclosure.

FIG. 12 shows a block diagram of a communications manager that supports a timing advance command for downlink control information for transmission reception point operation in accordance with aspects of the present disclosure.

FIG. 13 shows a diagram of a system including a device that supports a timing advance command for downlink control information for transmission reception point operation in accordance with aspects of the present disclosure.

FIGS. 14 through 17 show flowcharts illustrating methods that support a timing advance command for downlink control information for transmission reception point operation in accordance with aspects of the present disclosure.

### DETAILED DESCRIPTION

In some wireless communications systems, a user equipment (UE) may communicate with multiple transmission reception points. A transmission reception point may be a wireless communication device that may be capable of transmitting signals, receiving signals, or both. A base station and a UE may each be examples of a transmission reception point. In some examples, the UE may communicate with multiple base stations at the same time. The UE may communicate with the multiple transmission reception points using different channel resources associated with each transmission reception point. For example, the UE may communicate with a first transmission reception point using a first uplink channel, such as a first physical uplink shared channel (PUSCH) resource, and a first downlink channel, such as a first physical downlink control channel (PDCCH) resource, while communicating with a second transmission reception point using a second uplink channel, such as a second PUSCH resource, and a second downlink channel, such as a second PDCCH resource. The UE may communicate with the transmission reception points using uplink and downlink signaling.

In some examples, the multiple transmission reception points may experience propagation delay (e.g., different propagation delay) when communicating with the UE. Propagation delay may increase latency and decrease reliability in communications, among other issues. To mitigate the effects of propagation delay, the UE may determine a timing advance value and apply the timing advance value to offset the uplink communications. However, the UE may apply the same timing advance value to all the of the multiple transmission reception points even though the transmission reception points may experience different respective propagation delays. This may result is timing misalignment when communicating with multiple transmission reception points.

Techniques described herein support timing advance command for multiple downlink control information based multiple transmission reception points. A serving cell may be referred to as a connection point within a wireless network that provides wireless communication services over a geographical area. In some examples, transmission reception points in a common serving cell may have the same timing advance group, and transmission reception points within the same serving cell may have the same timing advance group identifier. Additionally or alternatively, transmission reception points that function independently of each other may have different timing advance group identifiers.

A UE may receive a control message (e.g. medium access control (MAC) control element (CE)) with a timing advance indication for the transmission reception points. In some cases, the UE may receive a control message, for examples, from each transmission reception point. Each control message may include a timing advance group identifier associated with a transmission reception point and a timing advance command. In some cases, the control message may additionally or alternatively include a transmission reception point identification within the control message. In some cases, the UE may receive a single timing advance indication that may indicate multiple (e.g., two) transmission reception point timing advance commands (e.g., corresponding to two transmission reception points). The timing advance indication may include multiple timing advance commands corresponding to each transmission reception point, and each timing advance command may also include a respective transmission reception point identifier. The UE may use the timing advance command to determine a timing advance value associated with each transmission reception point identifier or timing advance group identifier (corresponding to each transmission reception point). The UE may use the determined timing advance value when transmitting uplink signals to the respective transmission reception point.

Particular implementations of the subject matter described in this disclosure can be implemented to realize one or more of the following potential advantages. For example, increased reliability may be experienced as the communication between devices is synchronized based on using respective timing advances for the various devices. Additionally, the UE may experience improved efficiency due to eliminating out-of-sync communications and related additional signaling that may otherwise result from the out-of-sync communications. Further, in some examples, the timing advance command configuration as described herein may support higher data rates and diversity for control and data, thereby improving latency and reliability. As such, supported techniques may include improved network operations, and, in some examples, may promote network efficiencies, among other benefits.

Aspects of the disclosure are initially described in the context of wireless communications systems. An additional wireless communications system, examples of reference timing, examples of control message formatting, and process flows are then provided to describe aspects of the disclosure. Aspects of the disclosure are further illustrated by and described with reference to apparatus diagrams, system diagrams, and flowcharts that relate to timing advance command for downlink control information for transmission reception point operation.

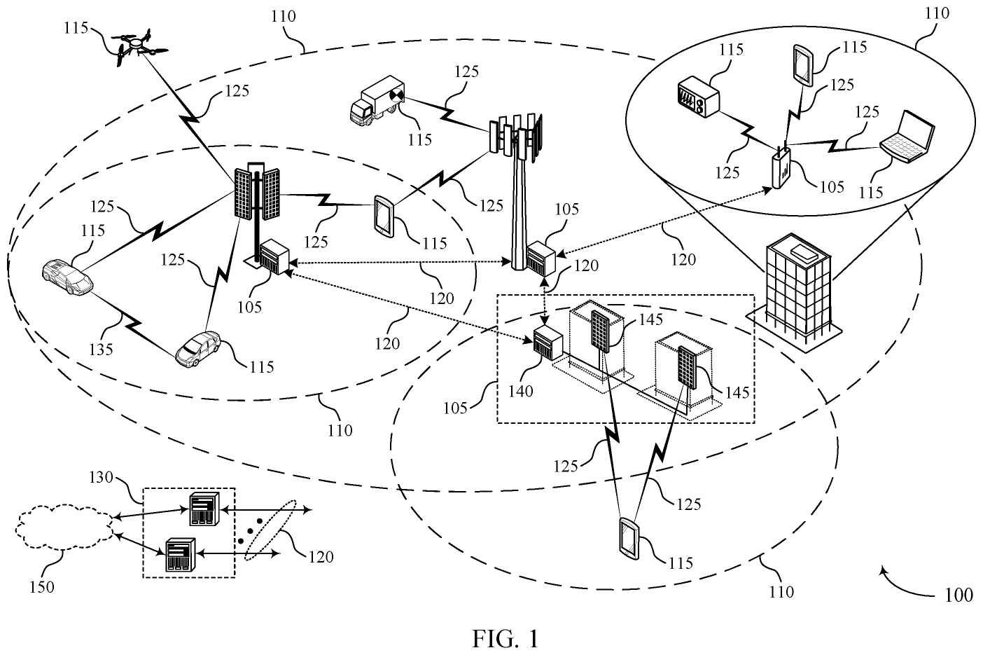

FIG. 1 illustrates an example of a wireless communications system 100 that supports a timing advance command for downlink control information for transmission reception point operation in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

In some examples, one or more components of the wireless communications system 100 may operate as or be referred to as a network node. As used herein, a network node may refer to any UE 115, base station 105, entity of a core network 130, apparatus, device, or computing system configured to perform any techniques described herein. For example, a network node may be a UE 115. As another example, a network node may be a base station 105. As another example, a first network node may be configured to communicate with a second network node or a third network node. In one aspect of this example, the first network node may be a UE 115, the second network node may be a base station 105, and the third network node may be a UE 115. In another aspect of this example, the first network node may be a UE 115, the second network node may be a base station 105, and the third network node may be a base station 105. In yet other aspects of this example, the first, second, and third network nodes may be different. Similarly, reference to a UE 115, a base station 105, an apparatus, a device, or a computing system may include disclosure of the UE 115, base station 105, apparatus, device, or computing system being a network node. For example, disclosure that a UE 115 is configured to receive information from a base station 105 also discloses that a first network node is configured to receive information from a second network node. In this example, consistent with this disclosure, the first network node may refer to a first UE 115, a first base station 105, a first apparatus, a first device, or a first computing system configured to receive the information; and the second network node may refer to a second UE 115, a second base station 105, a second apparatus, a second device, or a second computing system.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1: M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission reception points. Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

A base station 105 may indicate a timing advance parameter to the UE 115 via control signaling (e.g., RRC). The UE 115 may use the timing advance parameter to determine the propagation delay experienced from a transmission reception point. In some examples, the UE 115 may compensate for such propagation delays by determining a timing advance value. The UE 115 may use the timing advance value to send an uplink transmission to a transmission reception point. Multiple transmission reception points may experience different propagation delays, however a UE 115 may use a single timing advance value. The UE 115 may apply a common timing advance when communicating with multiple transmission reception points. While this may effectively synchronize communication between the UE and one transmission reception point, communication with the other transmission reception points may be misaligned in time leading to decreased reliability.

Techniques described herein provide for configuring different timing advance values for different uplink channels or resources. A UE 115 may receive a control signal (e.g., MAC-CE) which includes a timing advance indicator for multiple transmission reception points. In some examples, transmission reception points may include one or more base stations 105. The control signal may include timing advance group identifiers that each map to a transmission reception point. Additionally, the control signal may contain a timing advance command associated with each timing advance group identifier and transmission reception point. Alternatively, a transmission reception point identifier may be included in the timing advance command. Thus, the UE 115 may receive a timing advance command corresponding to each transmission reception point. In some cases, a UE 115 may receive multiple control signals, one from each transmission reception point. In this case, each control signal may include a corresponding timing advance group identifier or transmission reception point identifier. Each control signal may also include a timing advance command. The UE may use the received timing advance commands to determine a timing advance value to use in uplink transmissions to the multiple transmission receptions points.

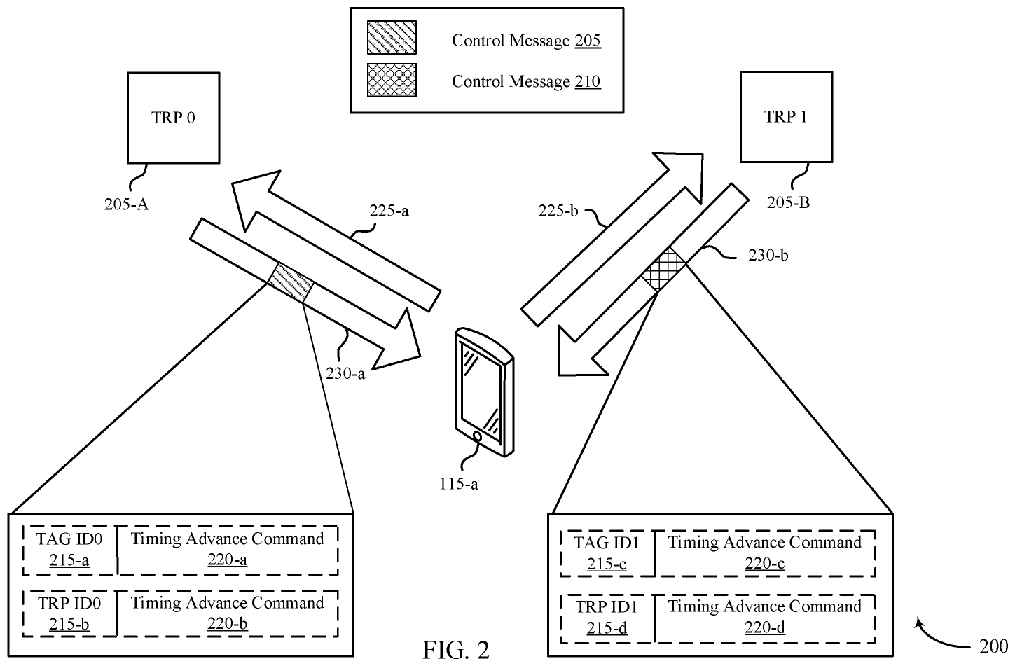

FIG. 2 illustrates an example of a wireless communications system 200 that supports a timing advance command for downlink control information for transmission reception point operation in accordance with aspects of the present disclosure. In some examples, wireless communications system 200 may be implemented by one or more aspects of wireless communications system 100. For instance, transmission reception point 205-a and transmission reception point 205-b may each be an example of a base station 105 as described with reference to FIG. 1. Additionally or alternatively, UE 115-a may be an example of a UE 115 as described with reference to FIG. 1.

A UE 115-a may communicate with a transmission reception point (e.g., a base station 105). In some examples, the UE 115-a may communicate with multiple transmission reception points in an multiple transmission reception point mode. For instance, the UE 115-a may perform simultaneous communications with a first transmission reception point and a second transmission reception point. In some examples, communicating with a transmission reception point may include the UE 115-a receiving downlink control information and scheduling uplink communications in accordance with the downlink control information. In some instances, a UE 115-a may receive a timing indication from a base station or another network entity. The UE 115-a may use the timing indication to determine a timing advance value. The UE 115-a may then apply the timing advance value to offset a timing for communication between a base station and the UE 115-a. For instance, the UE 115-a may determine that a propagation delay between the UE 115-a and the base station (e.g., a transmission reception point). The UE 115-a may use the timing advance value to offset an uplink transmission to the base station such that the propagation delay is reduced. When communicating in a multiple transmission reception point mode, transmitting multiple uplink communications with a common timing advance value may increase a latency associated with communications between the UE 115 and at least one of the transmission reception points. Techniques that decrease the latency associated with uplink communications with multiple transmission reception points may increase the efficiency of communications.

Techniques depicted herein provide for the UE 115-a to receive a timing advance value per transmission reception point. In particular, the UE 115-a may establish communication with a first transmission reception point (TRP 0) and a second transmission reception point (TRP 1). In some cases, the UE 115-a may receive an explicit transmission reception point identifier for communication. In other cases, the UE 115-a may receive an implicit transmission reception point identifier for communication. For example, a communication may be associated with different identifiers such as control resource set pool index, close loop index, and transmission configuration indication state. These identifiers may be associated with different transmission reception points. The UE 115-a may receive a single control message including one or more respective timing advance indications for uplink channel transmissions to one or more respective transmission reception points (e.g., TRP 0 and TRP 1). In some examples, each timing advance indication of the one or more respective timing advance indications may identify a respective transmission reception point of the one or more respective transmission reception points that is associated with the uplink channel transmissions using a respective timing advance value. In some cases, the UE 115-a may receive a control message (e.g., MAC-CE) from each transmission reception point, where the control message includes a timing advance indication. Alternatively, the UE 115-a may receive a control message from a single transmission reception point (either TRP 0 or TRP 1), where the control message includes a respective timing advance indication for both transmission reception points. For example, the first transmission reception point 205-a (TRP 0) may send a control message 205 over a downlink channel 230-a. The control message 205, in some examples, may optionally include a timing advance group identifier 215-a (TAG ID 0) and a timing advance command 220-a. The timing advance group identifier 215-a may identify the serving cell associated with the first transmission reception point 205-a. Thus, the transmission reception points within the same serving cell may have the same timing advance group identifier.

Similarly, the second transmission reception point 205-b (TRP 1) may send a control message 210 over a downlink channel 230-b. The control message 210, in some examples, may optionally include a timing advance group identifier 215-c (TAG ID 1) and a timing advance command 220-c. Accordingly, the UE 115-a may identify that the timing advance command 220-a for the first transmission reception point 205-a (TRP 0) and the timing advance command 220-b for the second transmission reception point 205-c (TRP 1). In some cases, both transmission reception points (TRP 1 and TRP 0) may be associated with different serving cells and may experience different timing propagation delays. In some instances, the second transmission reception point 205-b (TRP 1) may send the control message 210 over a downlink channel 230-b, where the control message may include a timing advance group identifier 215-c that corresponds to the second transmission reception point 205-b (TRP 1) and is different from the timing advance group identifier 215-a (TAG ID 0).

Additionally or alternatively, the control messages 205 and 210 may each include a transmission reception point identifier instead of a timing advance group identifier. The UE 115-a may use the transmission reception point identifier in each control message to link the timing advance commands 220-b and 220-d with the corresponding transmission reception points. For instance, the control message 205 and the control message 210 may each optionally include a transmission reception point identifier to identify the intended transmission reception point. If per-transmission reception point timing advance indication is based on a timing advance group, then the transmission reception points may include timing advance group identifier in the same control messages. Thus, the first transmission reception point 205-a (TRP 0) may transmit the control message 205 with a transmission reception point identifier 215-b and a timing advance command 220-b while the second transmission reception point 205-b (TRP 1) may transmit a control message 210 with a transmission reception point identifier 215-d and a timing advance command 220-d.

In some examples, a transmission reception point (TRP 0 or TRP 1) may send both timing advance commands in a single control message. In such cases, the UE 115-a may receive a single control message including a first timing advance value corresponding to the first transmission reception point and a second respective timing advance value corresponding to the second transmission reception point. The UE 115-a may then determine the first timing advance value for the uplink channel transmissions to the first transmission reception point and the second timing advance value for the uplink channel transmissions to the second transmission reception point based on the single control message. In such cases, the UE 115-a may transmit, to the first transmission reception point and the second transmission reception point, uplink channel transmissions over respective uplink channels (e.g., uplink channel 225-a and uplink channel 225-b) using the first timing advance value determined for the first transmission reception point and the second timing advance value determined for the second transmission reception point.

The UE 115-a may use the received timing advance commands 220 to determine a timing advance value for each transmission reception point. The timing advance command 220-a may include a timing advance offset value N_{TA,offset} of the serving cell. If a timing advance offset N_{TA,offset} is not included in the timing advance command the UE 115-a may determine a default value of the timing advance offset for the serving cell. The UE 115-a may adjust uplink transmission timing on all the serving cells in the timing advance group based on the received timing offset value N_{TA,offset}. The UE 115-a may expect the received timing offset value N_{TA,offset} to be the same for all the serving cells in a timing advance group. Accordingly, the UE 115-a may adjust uplink transmissions based on the received timing advance command where the timing for uplink transmissions is the same for all the serving cells in the timing advance group.

In some examples, the timing advance command may also include an absolute timing advance value. In the case that the UE 115-a uses random access response (e.g., random access channel (RACH) communications), the UE 115-a may determine time alignment N_{TA} may as

$${N}_{TA} = {T}_{A} * 16 * \frac{64}{{2}^{μ}} ,$$

where 2^{μ} may be the subcarrier spacing of the first uplink transmission from the UE 115-a after the receiving the timing advance command and T_{A} may be index values.

Additionally or alternatively, the timing advance command may include a relative timing advance value. The UE 115-a may determine the relative timing advance value based on an adjustment of a current time alignment value N_{TA_old}. The UE 115-a may determine the new time alignment value N_{TA_new} as

$${N}_{TA \_ new} = {N}_{TA \_ old} + ( {T}_{A} - 31 ) * 16 * \frac{64}{{2}^{μ}} .$$

In some examples, the UE 115-a may determine the timing advance value as N_{TA}+N_{TA,offset}, where N_{TA} may be either an absolute timing advance value or relative timing advance value. The UE 115-a may then transmit uplink communications to the first transmission reception point (TRP 0) over channel 225-a using the timing advance value determined for the first transmission reception point (TRP 0) and may transmit uplink communications to the second transmission reception point (TRP 1) over the uplink channel 225-b using the timing advance value determined for the second transmission reception point (TRP 1).

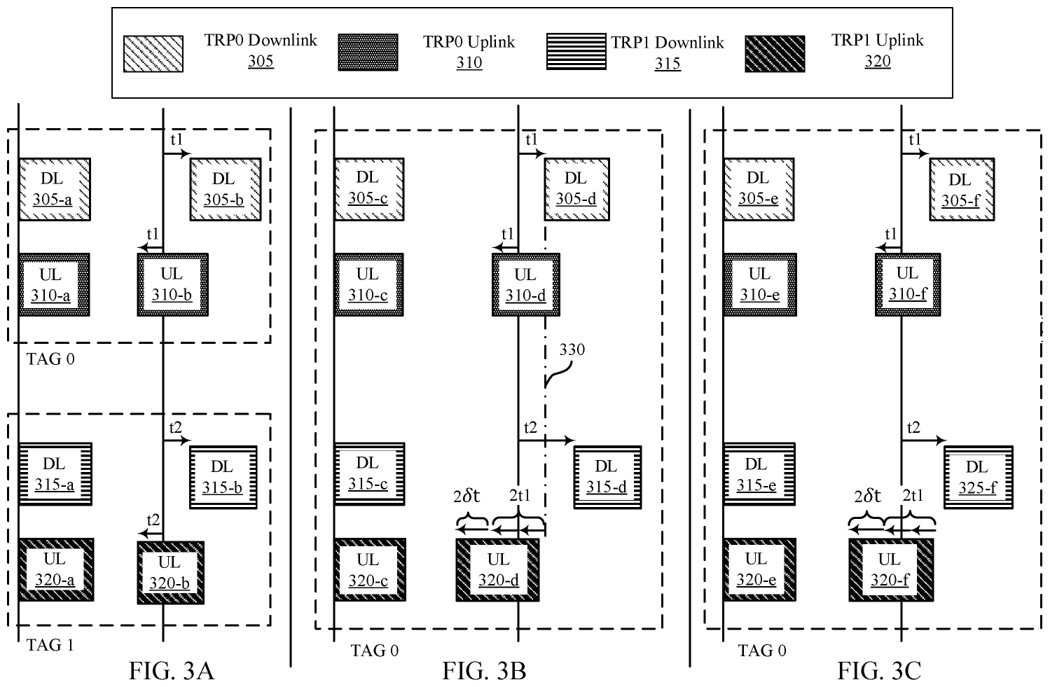

FIGS. 3A, 3B, and 3C illustrate examples of a wireless communications system 300 that supports a timing advance command for downlink control information for transmission reception point operation in accordance with aspects of the present disclosure. In some cases, a UE 115 may calculate a timing advance value associated with a transmission reception point based on a reference timing signal. For instance, a transmission reception point may transmit a single control message including a respective timing advance value for a transmission reception point.

As depicted in the example of FIG. 3, a reference timing may refer to the point in time at which a downlink frame is received from a reference cell (e.g., downlink signal 305 and downlink signal 315). For example, a transmission reception point may send a downlink signal to a UE 115. The UE 115, due to propagation delay for instance, may receive downlink signal with some time delay. The UE 115 may determine a timing advance value that is relative to when the downlink signal was received. The UE 115 may then send an uplink signal to the transmission reception point using the determined timing advance value.

In some cases, multiple transmission reception points may function independently of each other. For example, in FIG. 3A a first transmission reception point may be included in a timing advance group 0 (TAG 0) and a second transmission reception point may be included in a timing advance group 1 (TAG 1). When the first transmission reception point is synchronized with the UE 115, the downlink signal 305-a and the uplink signal 310-a may both be aligned in time. When the first transmission reception point is not synchronized with the UE 115 or if there is a mismatch in timing between the first transmission reception point and the UE 115, then the UE 115 may receive the downlink signal 305-b with a time propagation delay t1. As depicted in the example of FIG. 3A, the UE 115 may adjust the uplink communication timing by adjusting the uplink signal 310-b by a time interval t1. In this way, the first transmission reception point may perceive the uplink signal 310-b as being on-time. The second transmission reception point, included in TAG 1, may experience similar timing misalignment. However, the second transmission reception point may experience a time propagation delay t2 that may be different than t1. The UE 115 may determine a second timing advance value t2 corresponding to the second transmission reception point. Thus, when transmission reception points function independently of each other, a UE 115 may determine a timing advance value corresponding to each transmission reception point and adjust the uplink transmission accordingly.

In some cases, the multiple transmission reception points may share a common reference time. In other words, the timing adjustments for the transmission reception points may be based on a single timing reference. In FIG. 3B a first transmission reception point with a time propagation delay t1 may have the same timing advance group identifier, TAG 0, as a second transmission reception point with a time propagation delay t2. In this example, both transmission reception points may share a common reference time 330. The UE 115 may determine the common reference time using the first downlink signal 305-d received by the UE 115. The first transmission reception point may transmit the first downlink signal 305-c and the second transmission reception point may transmit the second downlink signal 315-c. For example, the UE 115 may receive the downlink signal 305-d with a time propagation delay t1. The UE may transmit the uplink signal 310-d with a timing advance value based on the timing delay t1. The UE may then receive the downlink signal 315-d from the second transmission reception point with a timing propagation delay t2 that may be different than t1. However, the UE may determine the timing advance value for uplink signal 320-d based at least in part on the common reference time 330 rather than the reference timing associated with the second downlink signal 315-d. For example, the timing advance value may be calculated as 2t1+2δt where δt represents a timing offset. Thus the UE may determine the timing advance value for the second transmission reception point as a function of the timing delay t1.

In some cases, the multiple transmission reception points may each have a respective reference time. As depicted in the example of FIG. 3C, a first transmission reception point may transmit the first downlink signal 305-e and the second transmission reception point may transmit the second downlink signal 315-e. The UE 115 may receive a downlink signal 305-f from the first transmission reception point with a time propagation delay t1. The UE 115 may determine a timing advance value t1 for the uplink signal 310-f based on the received downlink signal 305-f. In other words, the downlink signal 305-f may be a reference time for determining the timing advance value t1. The UE 115 may receive a second downlink signal 325-f from the second transmission reception point with a time propagation delay t2 which may be different from time propagation delay t1. The downlink signal 325-f may be a reference time for determining the timing advance value for the uplink signal 320-f. For example, the timing advance value may be calculated as 2t1+2δt where δt represents a timing offset. Thus, the UE may determine a timing advance value for the uplink signal 320-f based on the time delay 2t1+2δt.

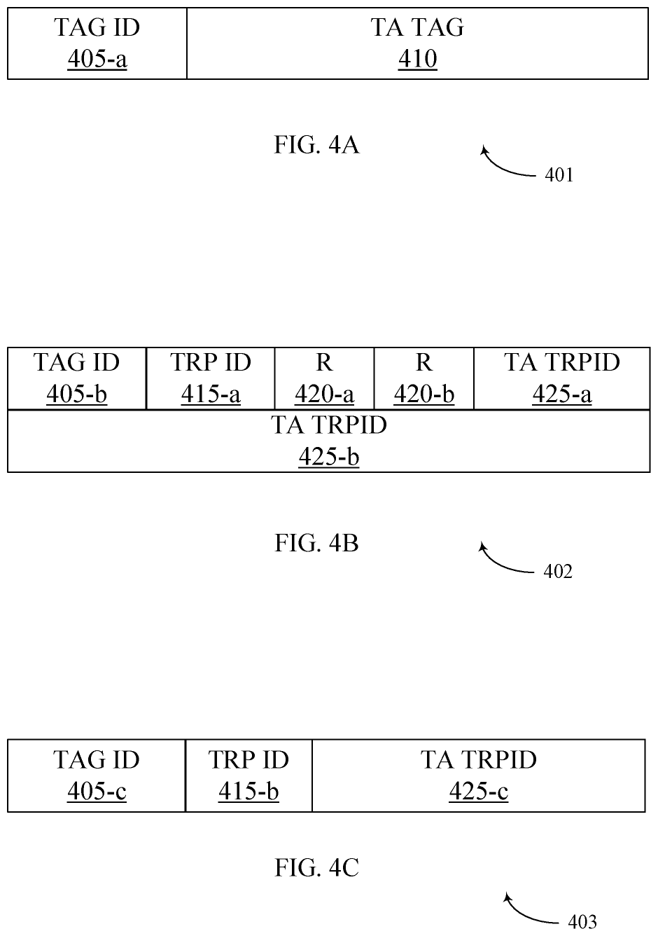

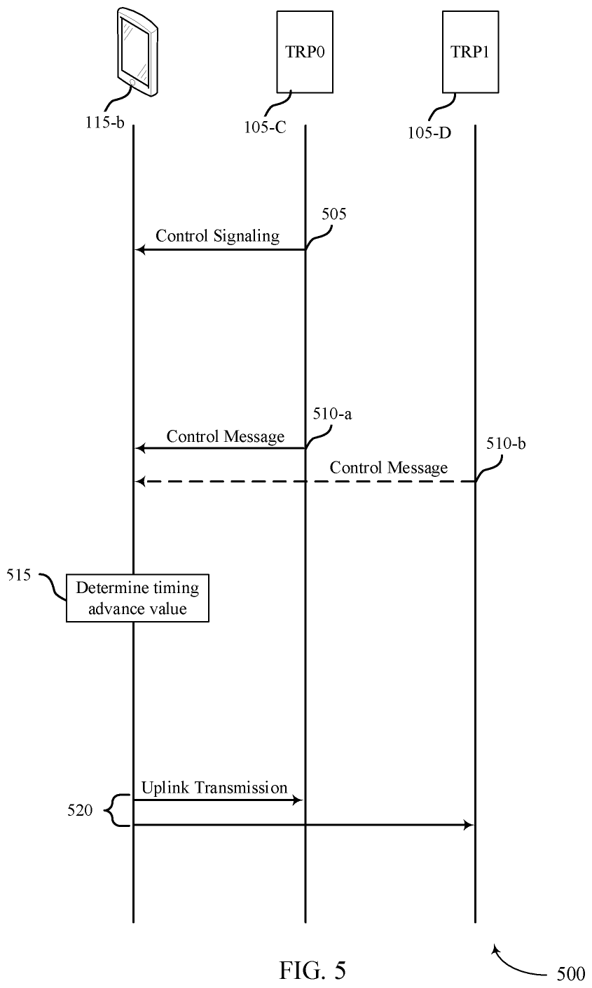

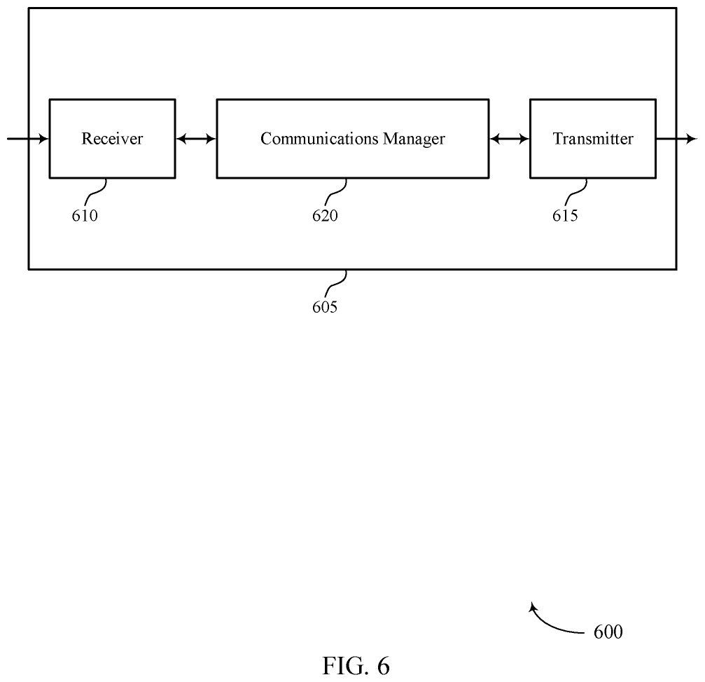

FIG. 4A illustrates an example of a control messages 401 that supports a timing advance command for downlink control information for transmission reception point operation in accordance with aspects of the present disclosure. FIG. 5B illustrates an example of a control messages 402 that supports a timing advance command for downlink control information for transmission reception point operation in accordance with aspects of the present disclosure. FIG. 6C illustrates an example of a control messages 403 that supports a timing advance command for downlink control information for transmission reception point operation in accordance with aspects of the present disclosure.

According to one or more aspects of the present disclosure, a UE 115 may receive a control message (e.g. MAC-CE) from a transmission reception point which may include a timing advance command or a per-transmission reception point timing advance command. The UE 115 may make timing adjustments for a transmission reception point based on the values included in the per-transmission reception point timing advance command. The timing advance command shown in FIG. 4A may correspond to a serving cell and apply to all transmission reception points within the serving cell area (e.g., having a common timing advance group identifier). The timing advance command may include a timing advance group identifier 405-a associated with the transmission reception point and a timing advance value 410 (e.g., timing advance value for a timing advance group). The timing advance group value 410 may include timing information such as the fixed timing advance offset experienced by the transmission reception point.

In some cases, the UE 115 may make timing adjustments based on the timing advance group value 410 and the transmission reception point timing advance 425 (e.g., timing advance value for a transmission reception point). As shown in FIG. 4B, a transmission reception point timing advance command may include a timing advance group identifier 405-b associated with the serving cell, a transmission reception point identifier 415-a associated with a specific transmission reception point, reserved segments 420-a and 420-b (e.g. error checking or reserved bits), and timing advance values 425-a and 425-b associated with the transmission reception point. In some cases, the UE 115 may determine a first timing adjustment value, N_{TA_new,TAG}, for the timing advance group based on an accumulation of the timing advance commands received from the timing advance group. For example, the first timing adjustment value may be calculated as

$${N}_{TA \_ new , TAG} = {N}_{TA \_ old , TAG} + ( {TA}_{, TAG} - 31 ) * 16 * \frac{64 {T}_{c}}{{2}^{u}} ,$$

where T_{c} is a time unit and u is 0, 1, 2, or 3 based on the subcarrier spacing applied for the timing advance. The UE 115 may also determine an overall timing advance value, N_{TA_new,TRPID}, for the transmission reception point. For example, the overall timing advance value may be calculated as N_{TA_new,TRPID}=N_{TA_new,TAG}+TA_{TRPID}*Tₛₜₑₚ, where Tₛₜₑₚ is a time unit.

Alternatively, as shown in FIG. 4C, a transmission reception point timing advance command may include a timing advance group identifier 405-c associated with the serving cell, a transmission reception point identifier 415-b associated with a specific transmission reception point, and a timing advance value 425-c associated with the transmission reception point. In some cases, the UE 115 may determine a first timing adjustment value, N_{TA_new,TAG}, for the timing advance group based on an accumulation of the timing advance commands received from the timing advance group. For example, the first timing adjustment value may be calculated as

$${N}_{TA \_ new , TAG} = {N}_{TA \_ old , TAG} + ( {TA}_{, TAG} - 31 ) * 16 * 64 \frac{{T}_{c}}{{2}^{u}} ,$$

where T_{c} is a time unit and u is 0, 1, 2, 3 based on the subcarrier spacing applied for the timing advance. The UE 115 may then determine a second timing advance value N_{TRPTA_new,TRPID} for the transmission reception point based on an accumulation of the transmission reception point timing advance command. For example, the second timing advance value may be calculated as N_{TRPTA}_{_{new,}}_{TRPID}=N_{TRPTA_old,TRPID}+TA_{TRPID}*Tₛₜₑₚ, where Tₛₜₑₚ is a time unit. The UE 115 may then determine an overall timing advance value N_{TA,TRPID} for the transmission reception point using the first and second timing adjustment values. For example, the overall timing advance value may be calculated as N_{TA,TRPID}=N_{TA_new,TAG}+N_{TRPTA_new,TRPID}. The UE 115 may use the timing advance value when transmitting uplink communications to the transmission reception point. The transmission reception point may perceive the timing advance value N_{TA,TRPID} based on a timing advance indicated in a timing advance group and a timing advance associated with a specific transmission reception point. For example, the perceived timing advance value may be calculated as N_{TA,TRPID}=T_{delta}+N_{perTRPTA,TRPID} where T_{delta}=N_{TA_new,TAG}, and N_{TRPTA,TRPID}=N_{TA_new,TRPID}.

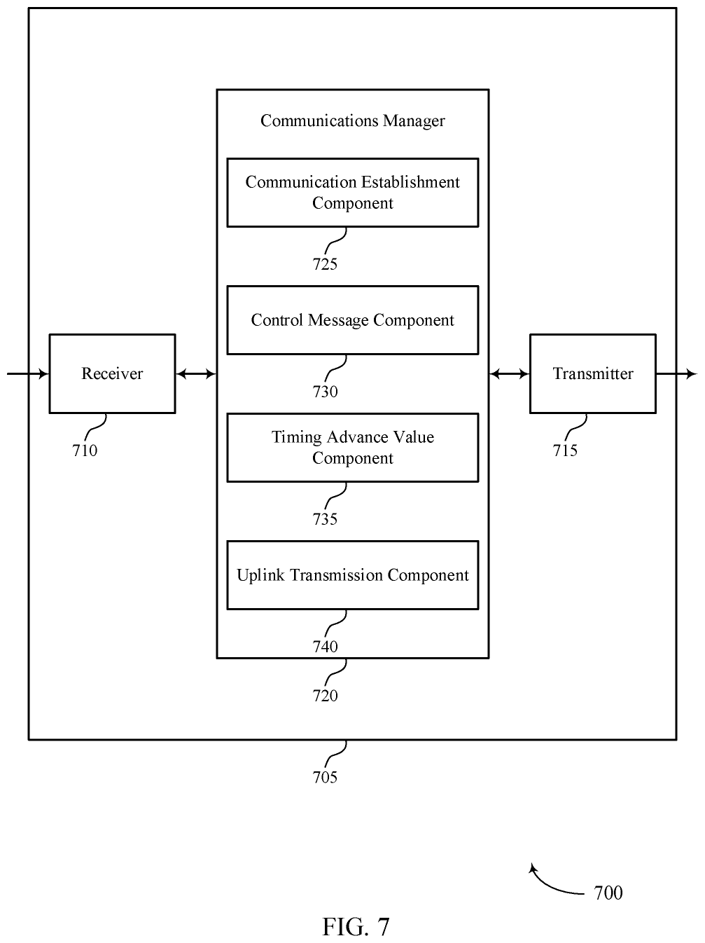

FIG. 7 illustrates an example of a process flow 700 that supports a timing advance command for downlink control information for transmission reception point operation in accordance with aspects of the present disclosure. In some examples, the process flow 500 may implement aspects of wireless communications system 100 and the wireless communications system 200 described with reference to FIGS. 1 and 2, respectively. For example, the process flow 500 may be based on one or more rules for timing advance determination in wireless communications systems. The process flow 500 may be implemented by the UE 115-b, a first transmission reception point 105-c (TRP 0), and a second transmission reception point 105-d (TRP 1) for reduced power consumption, and may promote low latency and low interference for wireless communications, among other benefits. The first transmission reception point 105-c (TRP 0), the second transmission reception point 105-d (TRP 1), and the UE 115-b may be examples of a base station 105 and a UE 115, as described with reference to FIGS. 1 and 2.

In the following description of the process flow 500, the operations between the first transmission reception point 105-c (TRP 0), the second transmission reception point 105-d (TRP 1), and the UE 115-b may be transmitted in a different order than the example order shown, or the operations performed by the first transmission reception point 105-c (TRP 0), the second transmission reception point 105-d (TRP 1), and the UE 115-b may be performed in different orders or at different times. Some operations may also be omitted from the process flow 500, and other operations may be added to the process flow 500.

At 505, the UE 115-b may receive control signaling (e.g., RRC) from transmission reception point 0. The control signaling may include a mapping between the timing advance group identifiers and the multiple transmission reception points (transmission reception point 0 and transmission reception point 1).

At 510-a, the UE 115-b may receive a control message (e.g., MAC-CE) from the first transmission reception point 105-c (TRP 0). The control message may include a timing advance indicator corresponding to the first transmission reception point 105-c (TRP 0), the second transmission reception point 105-d (TRP 1), or both. The timing advance indicator may include a timing advance group identifier or transmission reception point identifier associated with each of the transmission reception points (TRP 0 and TRP 1). The timing advance indicator may also include a timing advance command. Additionally or alternatively, at 510-b the UE 115-b may receive a control message from the second transmission reception point 105-d (TRP 1) with a timing advance indicator associated with the second transmission reception point 105-d (TRP 1). The control message may similarly include a timing advance group identifier or transmission reception point identifier associated with transmission reception point 1 and a timing advance command.

At 515, the UE 115-b may determine a timing advance value associated with the first transmission reception point 105-c (TRP 0), the second transmission reception point 105-d (TRP 1), or both. The UE 115-b may identify the first transmission reception point 105-c (TRP 0) and the second transmission reception point 105-d (TRP 1) using the timing advance group identifier or a transmission reception point identifier included in the received control message. The timing advance value for each transmission reception point may be based on the timing advance command received in the timing advance indicator. In some cases, the first transmission reception point 105-c (TRP 0) and the second transmission reception point 105-d (TRP 1) may share a common reference time. As such, the timing advance values for the first transmission reception point 105-c (TRP 0) and the second transmission reception point 105-d (TRP 1) may be dependent on each other. In other cases, the first transmission reception point 105-c (TRP 0) and the second transmission reception point 105-d (TRP 1) may function independently of each other and the timing advance values associated with the transmission reception points may be determined independently of each other.

At 520, the UE 115-b may transmit an uplink signal to the first transmission reception point 105-c (TRP 0), the second transmission reception point 105-d (TRP 1), or both. The UE 115-b may transmit the uplink signal transmitted to the first transmission reception point 105-c (TRP 0) using the determined timing advance value associated with the first transmission reception point 105-c (TRP 0). Additionally or alternatively, the UE 115-b may transmit the uplink signal to the second transmission reception point 105-d (TRP 1) may be sent using the determined timing advance value associated with the second transmission reception point 105-d (TRP 1).

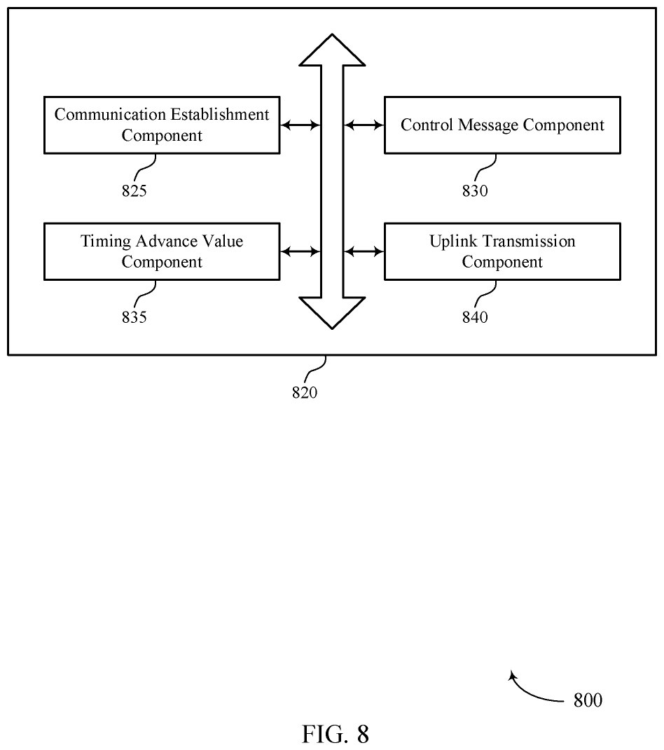

FIG. 8 shows a block diagram 800 of a device 805 that supports a timing advance command for downlink control information for transmission reception point operation in accordance with aspects of the present disclosure. The device 805 may be an example of aspects of a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to timing advance command for downlink control information for transmission reception point operation). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to timing advance command for downlink control information for transmission reception point operation). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of timing advance command for downlink control information for transmission reception point operation as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 820 may be configured to perform various operations (e.g., receiving, monitoring, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to receive information, transmit information, or perform various other operations as described herein.

The communications manager 820 may support wireless communication at a UE in accordance with examples as disclosed herein. For example, the communications manager 820 may be configured as or otherwise support a means for establishing communication with a set of multiple transmission reception points including a first transmission reception point and a second transmission reception point. The communications manager 820 may be configured as or otherwise support a means for receiving a single control message including one or more respective timing advance indications for uplink channel transmissions to one or more respective transmission reception points of the set of multiple transmission reception points, each timing advance indication of the one or more respective timing advance indications identifying a respective transmission reception point of the one or more respective transmission reception points that is associated with the uplink channel transmissions using a respective timing advance value. The communications manager 820 may be configured as or otherwise support a means for determining a first timing advance value for the uplink channel transmissions to the first transmission reception point of the one or more respective transmission reception points based on the one or more respective timing advance indications identifying the respective transmission reception point of the one or more respective transmission reception points. The communications manager 820 may be configured as or otherwise support a means for transmitting, to the first transmission reception point of the one or more respective transmission reception points, an uplink channel transmission over an uplink channel using the first timing advance value determined for the first transmission reception point.

By including or configuring the communications manager 820 in accordance with examples as described herein, the device 805 (e.g., a processor controlling or otherwise coupled to the receiver 810, the transmitter 815, the communications manager 820, or a combination thereof) may support techniques for reduced processing, reduced power consumption, more efficient utilization of communication resources.

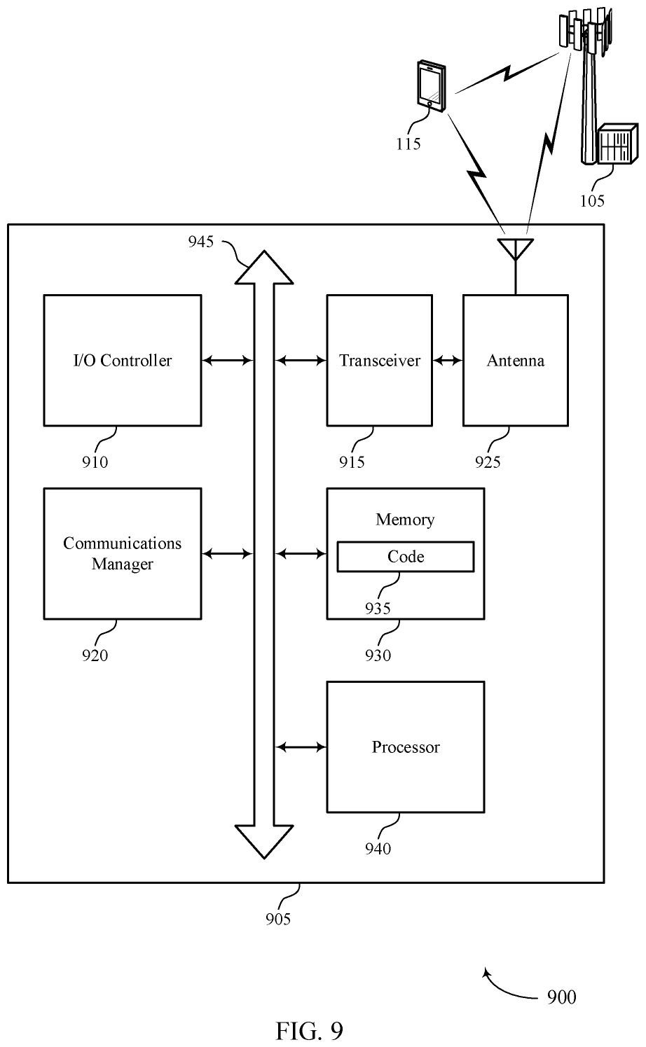

FIG. 9 shows a block diagram 900 of a device 905 that supports a timing advance command for downlink control information for transmission reception point operation in accordance with aspects of the present disclosure. The device 905 may be an example of aspects of a device 805 or a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to timing advance command for downlink control information for transmission reception point operation). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to timing advance command for downlink control information for transmission reception point operation). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of timing advance command for downlink control information for transmission reception point operation as described herein. For example, the communications manager 920 may include a communication establishment component 925, a control message component 930, a timing advance value component 935, an uplink transmission component 940, or any combination thereof. The communications manager 920 may be an example of aspects of a communications manager 820 as described herein. In some examples, the communications manager 920, or various components thereof, may be configured to perform various operations (e.g., receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations as described herein.

The communications manager 920 may support wireless communication at a UE in accordance with examples as disclosed herein. The communication establishment component 925 may be configured as or otherwise support a means for establishing communication with a set of multiple transmission reception points including a first transmission reception point and a second transmission reception point. The control message component 930 may be configured as or otherwise support a means for receiving a single control message including one or more respective timing advance indications for uplink channel transmissions to one or more respective transmission reception points of the set of multiple transmission reception points, each timing advance indication of the one or more respective timing advance indications identifying a respective transmission reception point of the one or more respective transmission reception points that is associated with the uplink channel transmissions using a respective timing advance value. The timing advance value component 935 may be configured as or otherwise support a means for determining a first timing advance value for the uplink channel transmissions to the first transmission reception point of the one or more respective transmission reception points based on the one or more respective timing advance indications identifying the respective transmission reception point of the one or more respective transmission reception points. The uplink transmission component 940 may be configured as or otherwise support a means for transmitting, to the first transmission reception point of the one or more respective transmission reception points, an uplink channel transmission over an uplink channel using the first timing advance value determined for the first transmission reception point.

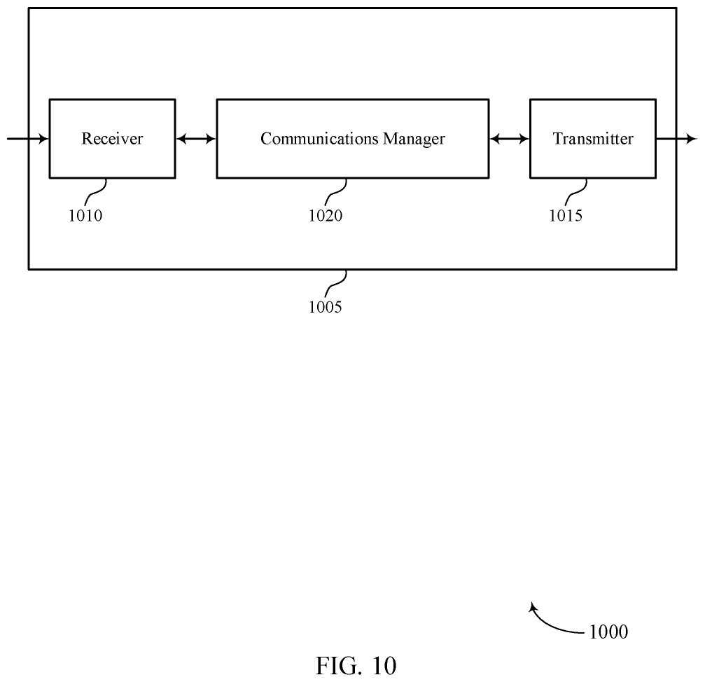

FIG. 10 shows a block diagram 1000 of a communications manager 1020 that supports a timing advance command for downlink control information for transmission reception point operation in accordance with aspects of the present disclosure. The communications manager 1020 may be an example of aspects of a communications manager 820, a communications manager 920, or both, as described herein. The communications manager 1020, or various components thereof, may be an example of means for performing various aspects of timing advance command for downlink control information for transmission reception point operation as described herein. For example, the communications manager 1020 may include a communication establishment component 1025, a control message component 1030, a timing advance value component 1035, an uplink transmission component 1040, or any combination thereof. Each of these components may communicate, directly or indirectly, with one another (e.g., via one or more buses).

The communications manager 1020 may support wireless communication at a UE in accordance with examples as disclosed herein. The communication establishment component 1025 may be configured as or otherwise support a means for establishing communication with a set of multiple transmission reception points including a first transmission reception point and a second transmission reception point. The control message component 1030 may be configured as or otherwise support a means for receiving a single control message including one or more respective timing advance indications for uplink channel transmissions to one or more respective transmission reception points of the set of multiple transmission reception points, each timing advance indication of the one or more respective timing advance indications identifying a respective transmission reception point of the one or more respective transmission reception points that is associated with the uplink channel transmissions using a respective timing advance value. The timing advance value component 1035 may be configured as or otherwise support a means for determining a first timing advance value for the uplink channel transmissions to the first transmission reception point of the one or more respective transmission reception points based on the one or more respective timing advance indications identifying the respective transmission reception point of the one or more respective transmission reception points. The uplink transmission component 1040 may be configured as or otherwise support a means for transmitting, to the first transmission reception point of the one or more respective transmission reception points, an uplink channel transmission over an uplink channel using the first timing advance value determined for the first transmission reception point.

In some examples, to support receiving the single control message including the one or more respective timing advance indications, the control message component 1030 may be configured as or otherwise support a means for receiving a first control message including a first timing advance command indication corresponding to the first transmission reception point of the one or more respective transmission reception points. In some examples, to support receiving the single control message including the one or more respective timing advance indications, the control message component 1030 may be configured as or otherwise support a means for receiving a second control message including a second timing advance command indication corresponding to the second transmission reception point of the one or more respective transmission reception points.

In some examples, the timing advance value component 1035 may be configured as or otherwise support a means for determining the first transmission reception point based on a first timing advance group identifier included in the first control message. In some examples, the timing advance value component 1035 may be configured as or otherwise support a means for determining the second transmission reception point based on a second timing advance group identifier included in the second control message, where transmitting the uplink channel transmission is based on determining the first transmission reception point and the second transmission reception point.

In some examples, the control message component 1030 may be configured as or otherwise support a means for receiving a control signaling indicating a mapping between a set of multiple timing advance group identifiers and the set of multiple transmission reception points, where the set of multiple timing advance group identifiers includes the first timing advance group identifier and the second timing advance group identifier, and where transmitting the uplink channel transmission is based on receiving the control signaling indicating the mapping.

In some examples, the timing advance value component 1035 may be configured as or otherwise support a means for determining the first transmission reception point based on a first transmission reception point identifier included in the first control message. In some examples, the timing advance value component 1035 may be configured as or otherwise support a means for determining the second transmission reception point based on a second transmission reception point identifier included in the second control message, where transmitting the uplink channel transmission is based on determining the first transmission reception point and the second transmission reception point.

In some examples, the timing advance value component 1035 may be configured as or otherwise support a means for determining that the first timing advance command indication and the second timing advance command indication are associated with a common timing advance group identifier, where transmitting the uplink channel transmission is based on determining that the first timing advance command indication and the second timing advance command indication are associated with the common timing advance group identifier.

In some examples, to support receiving the single control message including the one or more respective timing advance indications, the control message component 1030 may be configured as or otherwise support a means for receiving the single control message including the first timing advance value corresponding to the first transmission reception point and a second respective timing advance value corresponding to the second transmission reception point.

In some examples, the control message component 1030 may be configured as or otherwise support a means for receiving a second control message including a timing advance group identifier and a reference timing advance value associated with the timing advance group identifier, where determining the first timing advance value for the uplink channel transmissions to the first transmission reception point is based on receiving the second control message.

In some examples, the timing advance value component 1035 may be configured as or otherwise support a means for refraining from accumulating the one or more respective timing advance indications, where determining the first timing advance value for the uplink channel transmissions to the first transmission reception point is based on refraining from accumulating the one or more respective timing advance indications.

In some examples, the timing advance value component 1035 may be configured as or otherwise support a means for accumulating the one or more respective timing advance indications, where determining the first timing advance value for the uplink channel transmissions to the first transmission reception point is based on accumulating the one or more respective timing advance indications. In some examples, the single control message includes a medium access control layer control element.

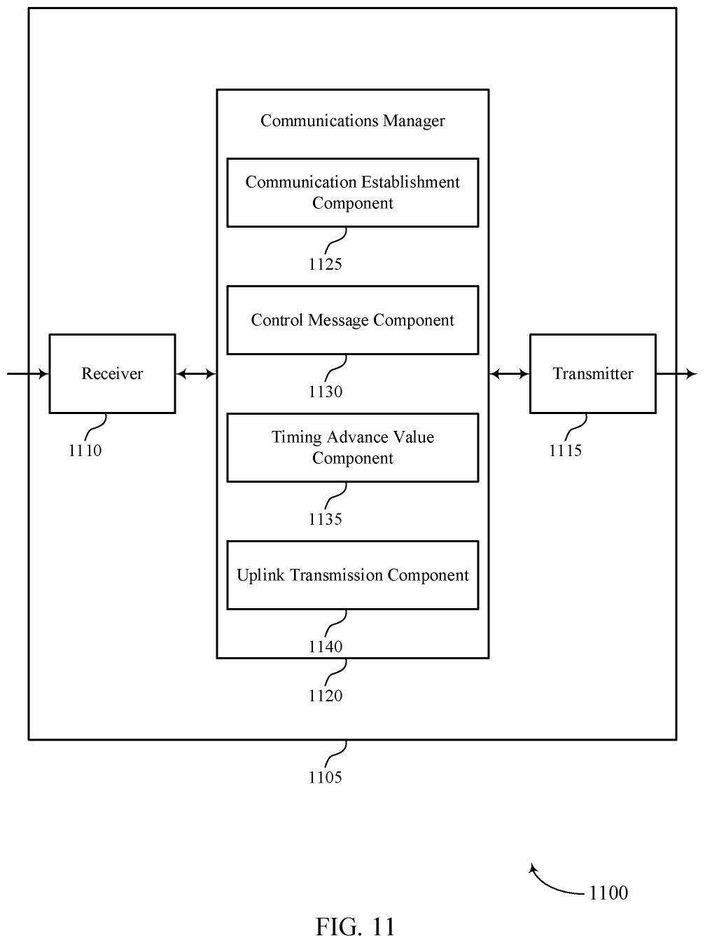

FIG. 11 shows a diagram of a system 1100 including a device 1105 that supports a timing advance command for downlink control information for transmission reception point operation in accordance with aspects of the present disclosure. The device 1105 may be an example of or include the components of a device 805, a device 905, or a UE 115 as described herein. The device 1105 may communicate wirelessly with one or more base stations 105, UEs 115, or any combination thereof. The device 1105 may include components for bi-directional voice and data communications including components for transmitting and receiving communications, such as a communications manager 1120, an input/output (I/O) controller 1110, a transceiver 1115, an antenna 1125, a memory 1130, code 1135, and a processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally or alternatively, the I/O controller 1110 may represent or interact with a modem, a keyboard, a mouse, a touchscreen, or a similar device. In some cases, the I/O controller 1110 may be implemented as part of a processor, such as the processor 1140. In some cases, a user may interact with the device 1105 via the I/O controller 1110 or via hardware components controlled by the I/O controller 1110.

In some cases, the device 1105 may include a single antenna 1125. However, in some other cases, the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The memory 1130 may include random access memory (RAM) and read-only memory (ROM). The memory 1130 may store computer-readable, computer-executable code 1135 including instructions that, when executed by the processor 1140, cause the device 1105 to perform various functions described herein. The code 1135 may be stored in a non-transitory computer-readable medium such as system memory or another type of memory. In some cases, the code 1135 may not be directly executable by the processor 1140 but may cause a computer (e.g., when compiled and executed) to perform functions described herein. In some cases, the memory 1130 may contain, among other things, a basic I/O system (BIOS) which may control basic hardware or software operation such as the interaction with peripheral components or devices.

The processor 1140 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting timing advance command for downlink control information for transmission reception point operation). For example, the device 1105 or a component of the device 1105 may include a processor 1140 and memory 1130 coupled with or to the processor 1140, the processor 1140 and memory 1130 configured to perform various functions described herein.

The communications manager 1120 may support wireless communication at a UE in accordance with examples as disclosed herein. For example, the communications manager 1120 may be configured as or otherwise support a means for establishing communication with a set of multiple transmission reception points including a first transmission reception point and a second transmission reception point. The communications manager 1120 may be configured as or otherwise support a means for receiving a single control message including one or more respective timing advance indications for uplink channel transmissions to one or more respective transmission reception points of the set of multiple transmission reception points, each timing advance indication of the one or more respective timing advance indications identifying a respective transmission reception point of the one or more respective transmission reception points that is associated with the uplink channel transmissions using a respective timing advance value. The communications manager 1120 may be configured as or otherwise support a means for determining a first timing advance value for the uplink channel transmissions to the first transmission reception point of the one or more respective transmission reception points based on the one or more respective timing advance indications identifying the respective transmission reception point of the one or more respective transmission reception points. The communications manager 1120 may be configured as or otherwise support a means for transmitting, to the first transmission reception point of the one or more respective transmission reception points, an uplink channel transmission over an uplink channel using the first timing advance value determined for the first transmission reception point.

By including or configuring the communications manager 1120 in accordance with examples as described herein, the device 1105 may support techniques for improved communication reliability, reduced latency, improved user experience related to reduced processing, more efficient utilization of communication resources, and improved coordination between devices.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the processor 1140, the memory 1130, the code 1135, or any combination thereof. For example, the code 1135 may include instructions executable by the processor 1140 to cause the device 1105 to perform various aspects of timing advance command for downlink control information for transmission reception point operation as described herein, or the processor 1140 and the memory 1130 may be otherwise configured to perform or support such operations.

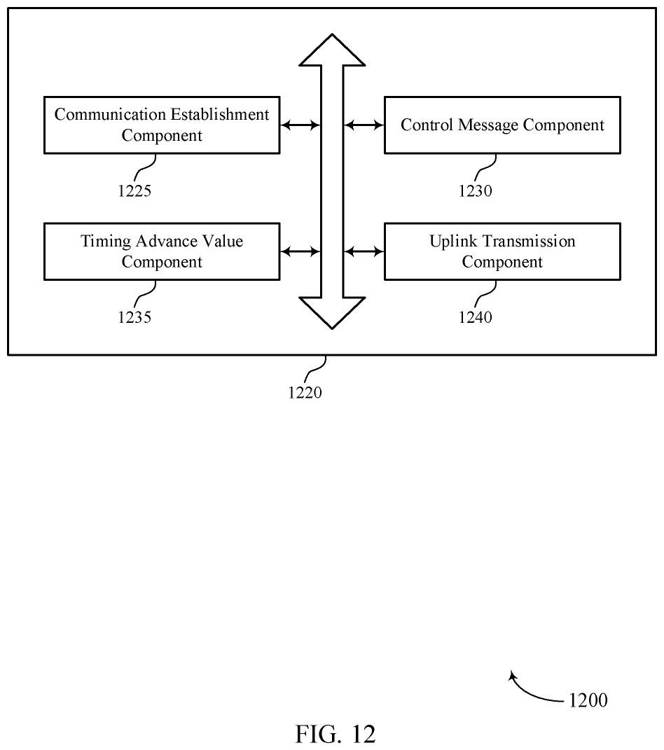

FIG. 12 shows a block diagram 1200 of a device 1205 that supports a timing advance command for downlink control information for transmission reception point operation in accordance with aspects of the present disclosure. The device 1205 may be an example of aspects of a network entity as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for receiving information such as packets, user data, control information, or any combination thereof associated with various information channels (e.g., control channels, data channels, information channels related to timing advance command for downlink control information for transmission reception point operation). Information may be passed on to other components of the device 1205. The receiver 1210 may utilize a single antenna or a set of multiple antennas.

The transmitter 1215 may provide a means for transmitting signals generated by other components of the device 1205. For example, the transmitter 1215 may transmit information such as packets, user data, control information, or any combination thereof associated with various information channels (e.g., control channels, data channels, information channels related to timing advance command for downlink control information for transmission reception point operation). In some examples, the transmitter 1215 may be co-located with a receiver 1210 in a transceiver module. The transmitter 1215 may utilize a single antenna or a set of multiple antennas.

The communications manager 1220, the receiver 1210, the transmitter 1215, or various combinations thereof or various components thereof may be examples of means for performing various aspects of timing advance command for downlink control information for transmission reception point operation as described herein. For example, the communications manager 1220, the receiver 1210, the transmitter 1215, or various combinations or components thereof may support a method for performing one or more of the functions described herein.

In some examples, the communications manager 1220, the receiver 1210, the transmitter 1215, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1220, the receiver 1210, the transmitter 1215, or various combinations or components thereof may be implemented in code (e.g., as communications management software or firmware) executed by a processor. If implemented in code executed by a processor, the functions of the communications manager 1220, the receiver 1210, the transmitter 1215, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 1220 may be configured to perform various operations (e.g., receiving, monitoring, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to receive information, transmit information, or perform various other operations as described herein.

The communications manager 1220 may support wireless communication at a network entity in accordance with examples as disclosed herein. For example, the communications manager 1220 may be configured as or otherwise support a means for establishing communication with a UE. The communications manager 1220 may be configured as or otherwise support a means for transmitting a single control message including one or more respective timing advance indications for uplink channel transmissions to one or more respective transmission reception points of a set of multiple transmission reception points including a first transmission reception point and a second transmission reception point, each timing advance indication of the one or more respective timing advance indications identifying a respective transmission reception point of the one or more respective transmission reception points that is associated with the uplink channel transmissions using a respective timing advance value. The communications manager 1220 may be configured as or otherwise support a means for determining a first timing advance value for the uplink channel transmissions to the first transmission reception point of the one or more respective transmission reception points based on the one or more respective timing advance indications identifying the respective transmission reception point of the one or more respective transmission reception points. The communications manager 1220 may be configured as or otherwise support a means for receiving an uplink channel transmission over an uplink channel using the first timing advance value determined for the first transmission reception point.

By including or configuring the communications manager 1220 in accordance with examples as described herein, the device 1205 (e.g., a processor controlling or otherwise coupled to the receiver 1210, the transmitter 1215, the communications manager 1220, or a combination thereof) may support techniques for reduced processing, reduced power consumption, and more efficient utilization of communication resources.

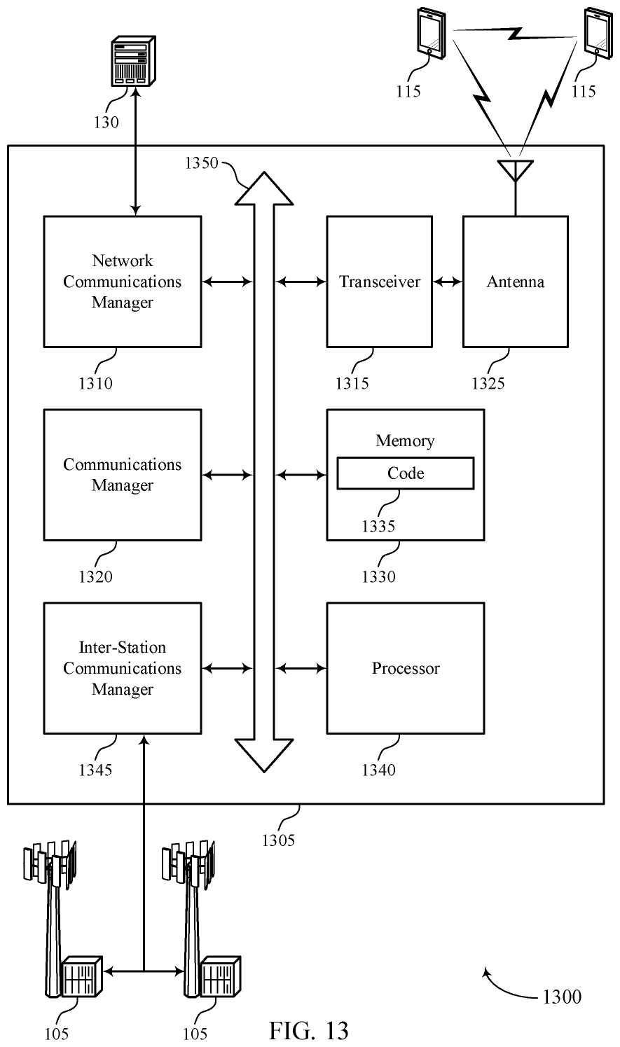

FIG. 13 shows a block diagram 1300 of a device 1305 that supports a timing advance command for downlink control information for transmission reception point operation in accordance with aspects of the present disclosure. The device 1305 may be an example of aspects of a device 1205 or a network entity or a base station 105 as described herein. The device 1305 may include a receiver 1310, a transmitter 1315, and a communications manager 1320. The device 1305 may also include a processor. Each of these components may be in communication with one another (e.g., via one or more buses).

The receiver 1310 may provide a means for receiving information such as packets, user data, control information, or any combination thereof associated with various information channels (e.g., control channels, data channels, information channels related to timing advance command for downlink control information for transmission reception point operation). Information may be passed on to other components of the device 1305. The receiver 1310 may utilize a single antenna or a set of multiple antennas.

The transmitter 1315 may provide a means for transmitting signals generated by other components of the device 1305. For example, the transmitter 1315 may transmit information such as packets, user data, control information, or any combination thereof associated with various information channels (e.g., control channels, data channels, information channels related to timing advance command for downlink control information for transmission reception point operation). In some examples, the transmitter 1315 may be co-located with a receiver 1310 in a transceiver module. The transmitter 1315 may utilize a single antenna or a set of multiple antennas.

The device 1305, or various components thereof, may be an example of means for performing various aspects of timing advance command for downlink control information for transmission reception point operation as described herein. For example, the communications manager 1320 may include a communication establishment component 1325, a control message component 1330, a timing advance value component 1335, an uplink transmission component 1340, or any combination thereof. The communications manager 1320 may be an example of aspects of a communications manager 1220 as described herein. In some examples, the communications manager 1320, or various components thereof, may be configured to perform various operations (e.g., receiving, monitoring, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to receive information, transmit information, or perform various other operations as described herein.

The communications manager 1320 may support wireless communication at a network entity in accordance with examples as disclosed herein. The communication establishment component 1325 may be configured as or otherwise support a means for establishing communication with a UE. The control message component 1330 may be configured as or otherwise support a means for transmitting a single control message including one or more respective timing advance indications for uplink channel transmissions to one or more respective transmission reception points of a set of multiple transmission reception points including a first transmission reception point and a second transmission reception point, each timing advance indication of the one or more respective timing advance indications identifying a respective transmission reception point of the one or more respective transmission reception points that is associated with the uplink channel transmissions using a respective timing advance value. The timing advance value component 1335 may be configured as or otherwise support a means for determining a first timing advance value for the uplink channel transmissions to the first transmission reception point of the one or more respective transmission reception points based on the one or more respective timing advance indications identifying the respective transmission reception point of the one or more respective transmission reception points. The uplink transmission component 1340 may be configured as or otherwise support a means for receiving an uplink channel transmission over an uplink channel using the first timing advance value determined for the first transmission reception point.

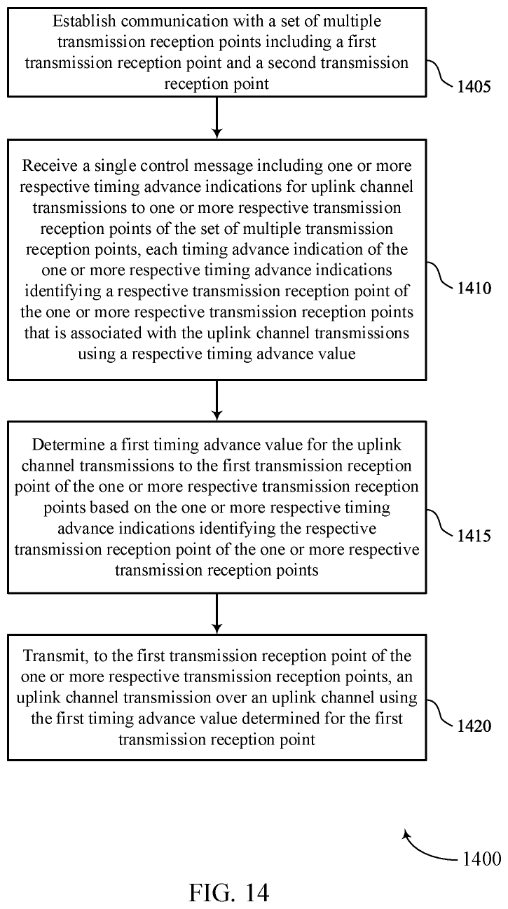

FIG. 14 shows a block diagram 1400 of a communications manager 1420 that supports a timing advance command for downlink control information for transmission reception point operation in accordance with aspects of the present disclosure. The communications manager 1420 may be an example of aspects of a communications manager 1220, a communications manager 1320, or both, as described herein. The communications manager 1420, or various components thereof, may be an example of means for performing various aspects of timing advance command for downlink control information for transmission reception point operation as described herein. For example, the communications manager 1420 may include a communication establishment component 1425, a control message component 1430, a timing advance value component 1435, an uplink transmission component 1440, or any combination thereof. Each of these components may communicate, directly or indirectly, with one another (e.g., via one or more buses).

The communications manager 1420 may support wireless communication at a network entity in accordance with examples as disclosed herein. The communication establishment component 1425 may be configured as or otherwise support a means for establishing communication with a UE. The control message component 1430 may be configured as or otherwise support a means for transmitting a single control message including one or more respective timing advance indications for uplink channel transmissions to one or more respective transmission reception points of a set of multiple transmission reception points including a first transmission reception point and a second transmission reception point, each timing advance indication of the one or more respective timing advance indications identifying a respective transmission reception point of the one or more respective transmission reception points that is associated with the uplink channel transmissions using a respective timing advance value. The timing advance value component 1435 may be configured as or otherwise support a means for determining a first timing advance value for the uplink channel transmissions to the first transmission reception point of the one or more respective transmission reception points based on the one or more respective timing advance indications identifying the respective transmission reception point of the one or more respective transmission reception points. The uplink transmission component 1440 may be configured as or otherwise support a means for receiving an uplink channel transmission over an uplink channel using the first timing advance value determined for the first transmission reception point.

In some examples, to support transmitting the single control message including the one or more respective timing advance indications, the control message component 1430 may be configured as or otherwise support a means for transmitting a second control message including a timing advance command indication corresponding to the first transmission reception point of the one or more respective transmission reception points.

In some examples, to support transmitting the second control message, the timing advance value component 1435 may be configured as or otherwise support a means for including a timing advance group identifier indicating the first transmission reception point in the second control message, where receiving the uplink channel transmission is based on including the timing advance group identifier in the second control message.

In some examples, the control message component 1430 may be configured as or otherwise support a means for transmitting a control signaling indicating a mapping between a set of multiple timing advance group identifiers and the set of multiple transmission reception points, where the set of multiple timing advance group identifiers includes the timing advance group identifier, and where receiving the uplink channel transmission is based on transmitting the control signaling indicating the mapping.

In some examples, to support transmitting the second control message, the control message component 1430 may be configured as or otherwise support a means for including a transmission reception point identifier indicating the first transmission reception point in the second control message, where receiving the uplink channel transmission is based on including the transmission reception point identifier in the second control message.

In some examples, to support transmitting the single control message including the one or more respective timing advance indications, the control message component 1430 may be configured as or otherwise support a means for transmitting the single control message including the first timing advance value corresponding to the first transmission reception point and a second respective timing advance value corresponding to the second transmission reception point.

In some examples, the control message component 1430 may be configured as or otherwise support a means for transmitting a second control message including a timing advance group identifier and a reference timing advance value associated with the timing advance group identifier, where determining the first timing advance value for the uplink channel transmissions to the first transmission reception point is based on transmitting the second control message.

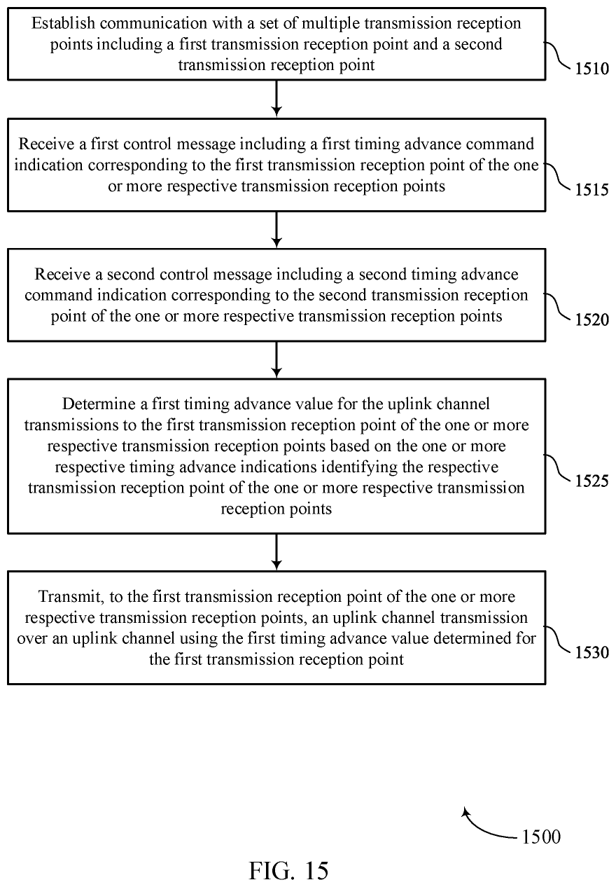

FIG. 15 shows a diagram of a system 1500 including a device 1505 that supports a timing advance command for downlink control information for transmission reception point operation in accordance with aspects of the present disclosure. The device 1505 may be an example of or include the components of a device 1205, a device 1305, or a network entity as described herein. The device 1505 may include components for bi-directional voice and data communications including components for transmitting and receiving communications, such as a communications manager 1520, a network communications manager 1510, a transceiver 1515, an antenna 1525, a memory 1530, code 1535, a processor 1540, and an inter-station communications manager 1545. These components may be in electronic communication or otherwise coupled (e.g., operatively, communicatively, functionally, electronically, electrically) via one or more buses (e.g., a bus 1550).

The network communications manager 1510 may manage communications with a core network 130 (e.g., via one or more wired backhaul links). For example, the network communications manager 1510 may manage the transfer of data communications for client devices, such as one or more UEs 115.

In some cases, the device 1505 may include a single antenna 1525. However, in some other cases the device 1505 may have more than one antenna 1525, which may be capable of concurrently transmitting or receiving multiple wireless transmissions. The transceiver 1515 may communicate bi-directionally, via the one or more antennas 1525, wired, or wireless links as described herein. For example, the transceiver 1515 may represent a wireless transceiver and may communicate bi-directionally with another wireless transceiver. The transceiver 1515 may also include a modem to modulate the packets, to provide the modulated packets to one or more antennas 1525 for transmission, and to demodulate packets received from the one or more antennas 1525. The transceiver 1515, or the transceiver 1515 and one or more antennas 1525, may be an example of a transmitter 1215, a transmitter 1315, a receiver 1210, a receiver 1310, or any combination thereof or component thereof, as described herein.

The memory 1530 may include RAM and ROM. The memory 1530 may store computer-readable, computer-executable code 1535 including instructions that, when executed by the processor 1540, cause the device 1505 to perform various functions described herein. The code 1535 may be stored in a non-transitory computer-readable medium such as system memory or another type of memory. In some cases, the code 1535 may not be directly executable by the processor 1540 but may cause a computer (e.g., when compiled and executed) to perform functions described herein. In some cases, the memory 1530 may contain, among other things, a BIOS which may control basic hardware or software operation such as the interaction with peripheral components or devices.

The processor 1540 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1540 may be configured to operate a memory array using a memory controller. In some other cases, a memory controller may be integrated into the processor 1540. The processor 1540 may be configured to execute computer-readable instructions stored in a memory (e.g., the memory 1530) to cause the device 1505 to perform various functions (e.g., functions or tasks supporting timing advance command for downlink control information for transmission reception point operation). For example, the device 1505 or a component of the device 1505 may include a processor 1540 and memory 1530 coupled to the processor 1540, the processor 1540 and memory 1530 configured to perform various functions described herein.

The inter-station communications manager 1545 may manage communications with other base stations 105, and may include a controller or scheduler for controlling communications with UEs 115 in cooperation with other base stations 105. For example, the inter-station communications manager 1545 may coordinate scheduling for transmissions to UEs 115 for various interference mitigation techniques such as beamforming or joint transmission. In some examples, the inter-station communications manager 1545 may provide an X2 interface within an LTE/LTE-A wireless communications network technology to provide communication between base stations 105.

The communications manager 1520 may support wireless communication at a network entity in accordance with examples as disclosed herein. For example, the communications manager 1520 may be configured as or otherwise support a means for establishing communication with a UE. The communications manager 1520 may be configured as or otherwise support a means for transmitting a single control message including one or more respective timing advance indications for uplink channel transmissions to one or more respective transmission reception points of a set of multiple transmission reception points including a first transmission reception point and a second transmission reception point, each timing advance indication of the one or more respective timing advance indications identifying a respective transmission reception point of the one or more respective transmission reception points that is associated with the uplink channel transmissions using a respective timing advance value. The communications manager 1520 may be configured as or otherwise support a means for determining a first timing advance value for the uplink channel transmissions to the first transmission reception point of the one or more respective transmission reception points based on the one or more respective timing advance indications identifying the respective transmission reception point of the one or more respective transmission reception points. The communications manager 1520 may be configured as or otherwise support a means for receiving an uplink channel transmission over an uplink channel using the first timing advance value determined for the first transmission reception point.

By including or configuring the communications manager 1520 in accordance with examples as described herein, the device 1505 may support techniques for improved communication reliability, reduced latency, improved user experience related to reduced processing, reduced power consumption, more efficient utilization of communication resources, and improved coordination between devices.

In some examples, the communications manager 1520 may be configured to perform various operations (e.g., receiving, monitoring, transmitting) using or otherwise in cooperation with the transceiver 1515, the one or more antennas 1525, or any combination thereof. Although the communications manager 1520 is illustrated as a separate component, in some examples, one or more functions described with reference to the communications manager 1520 may be supported by or performed by the processor 1540, the memory 1530, the code 1535, or any combination thereof. For example, the code 1535 may include instructions executable by the processor 1540 to cause the device 1505 to perform various aspects of timing advance command for downlink control information for transmission reception point operation as described herein, or the processor 1540 and the memory 1530 may be otherwise configured to perform or support such operations.

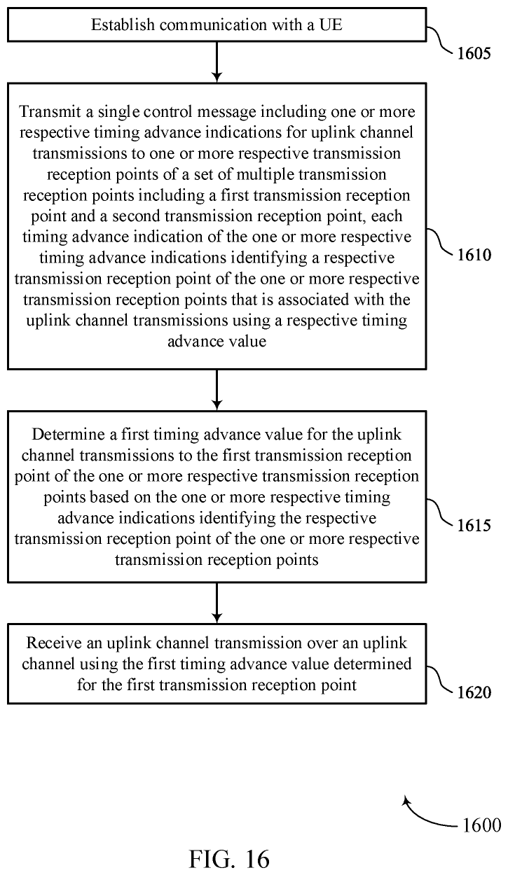

FIG. 16 shows a flowchart illustrating a method 1600 that supports a timing advance command for downlink control information for transmission reception point operation in accordance with aspects of the present disclosure. The operations of the method 1600 may be implemented by a UE or its components as described herein. For example, the operations of the method 1600 may be performed by a UE 115 as described with reference to FIGS. 1 through 11. In some examples, a UE may execute a set of instructions to control the functional elements of the UE to perform the described functions. Additionally or alternatively, the UE may perform aspects of the described functions using special-purpose hardware.

At 1605, the method may include establishing communication with a set of multiple transmission reception points including a first transmission reception point and a second transmission reception point. The operations of 1605 may be performed in accordance with examples as disclosed herein. In some examples, aspects of the operations of 1605 may be performed by a communication establishment component 1025 as described with reference to FIG. 10.

At 1610, the method may include receiving a single control message including one or more respective timing advance indications for uplink channel transmissions to one or more respective transmission reception points of the set of multiple transmission reception points, each timing advance indication of the one or more respective timing advance indications identifying a respective transmission reception point of the one or more respective transmission reception points that is associated with the uplink channel transmissions using a respective timing advance value. The operations of 1610 may be performed in accordance with examples as disclosed herein. In some examples, aspects of the operations of 1610 may be performed by a control message component 1030 as described with reference to FIG. 10.

At 1615, the method may include determining a first timing advance value for the uplink channel transmissions to the first transmission reception point of the one or more respective transmission reception points based on the one or more respective timing advance indications identifying the respective transmission reception point of the one or more respective transmission reception points. The operations of 1615 may be performed in accordance with examples as disclosed herein. In some examples, aspects of the operations of 1615 may be performed by a timing advance value component 1035 as described with reference to FIG. 10.

At 1620, the method may include transmitting, to the first transmission reception point of the one or more respective transmission reception points, an uplink channel transmission over an uplink channel using the first timing advance value determined for the first transmission reception point. The operations of 1620 may be performed in accordance with examples as disclosed herein. In some examples, aspects of the operations of 1620 may be performed by an uplink transmission component 1040 as described with reference to FIG. 10.

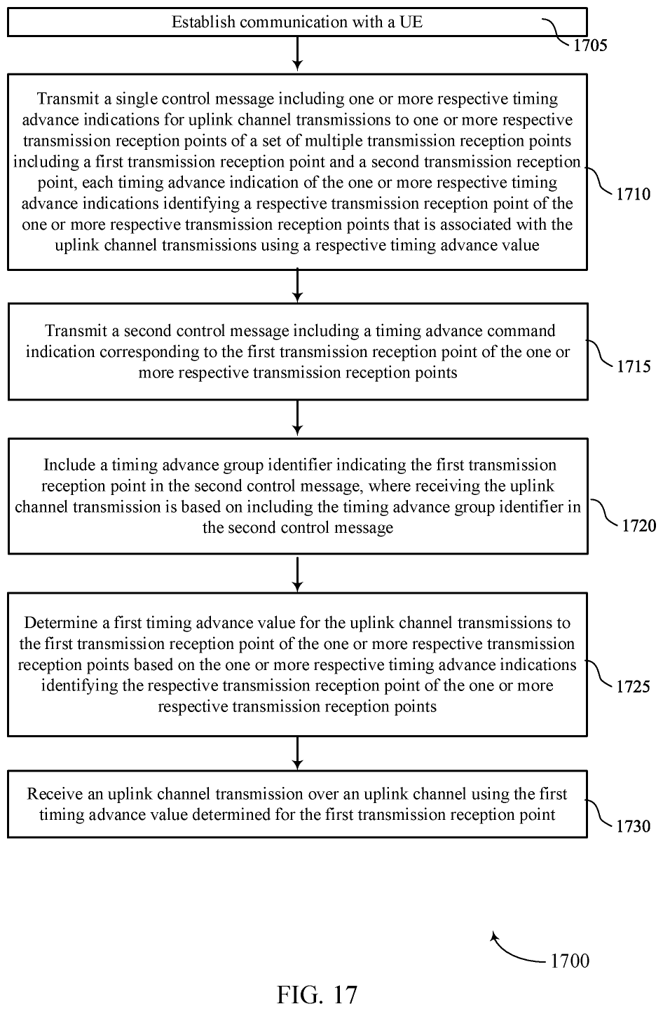

FIG. 17 shows a flowchart illustrating a method 1700 that supports a timing advance command for downlink control information for transmission reception point operation in accordance with aspects of the present disclosure. The operations of the method 1700 may be implemented by a UE or its components as described herein. For example, the operations of the method 1700 may be performed by a UE 115 as described with reference to FIGS. 1 through 11. In some examples, a UE may execute a set of instructions to control the functional elements of the UE to perform the described functions. Additionally or alternatively, the UE may perform aspects of the described functions using special-purpose hardware.

At 1710, the method may include establishing communication with a set of multiple transmission reception points including a first transmission reception point and a second transmission reception point. The operations of 1710 may be performed in accordance with examples as disclosed herein. In some examples, aspects of the operations of 1710 may be performed by a communication establishment component 1025 as described with reference to FIG. 10.

At 1715, the method may include receiving a first control message including a first timing advance command indication corresponding to the first transmission reception point of the one or more respective transmission reception points. The operations of 1715 may be performed in accordance with examples as disclosed herein. In some examples, aspects of the operations of 1715 may be performed by a control message component 1030 as described with reference to FIG. 10.

At 1720, the method may include receiving a second control message including a second timing advance command indication corresponding to the second transmission reception point of the one or more respective transmission reception points. The operations of 1720 may be performed in accordance with examples as disclosed herein. In some examples, aspects of the operations of 1720 may be performed by a control message component 1030 as described with reference to FIG. 10.

At 1725, the method may include determining a first timing advance value for the uplink channel transmissions to the first transmission reception point of the one or more respective transmission reception points based on the one or more respective timing advance indications identifying the respective transmission reception point of the one or more respective transmission reception points. The operations of 1725 may be performed in accordance with examples as disclosed herein. In some examples, aspects of the operations of 1725 may be performed by a timing advance value component 1035 as described with reference to FIG. 10.

At 1730, the method may include transmitting, to the first transmission reception point of the one or more respective transmission reception points, an uplink channel transmission over an uplink channel using the first timing advance value determined for the first transmission reception point. The operations of 1730 may be performed in accordance with examples as disclosed herein. In some examples, aspects of the operations of 1730 may be performed by an uplink transmission component 1040 as described with reference to FIG. 10.

FIG. 18 shows a flowchart illustrating a method 1800 that supports a timing advance command for downlink control information for transmission reception point operation in accordance with aspects of the present disclosure. The operations of the method 1800 may be implemented by a network entity or its components as described herein. For example, the operations of the method 1800 may be performed by a network entity as described with reference to FIGS. 1 through 7 and 12 through 15. In some examples, a network entity may execute a set of instructions to control the functional elements of the network entity to perform the described functions. Additionally or alternatively, the network entity may perform aspects of the described functions using special-purpose hardware.

At 1805, the method may include establishing communication with a UE.

The operations of 1805 may be performed in accordance with examples as disclosed herein. In some examples, aspects of the operations of 1805 may be performed by a communication establishment component 1425 as described with reference to FIG. 14.

At 1810, the method may include transmitting a single control message including one or more respective timing advance indications for uplink channel transmissions to one or more respective transmission reception points of a set of multiple transmission reception points including a first transmission reception point and a second transmission reception point, each timing advance indication of the one or more respective timing advance indications identifying a respective transmission reception point of the one or more respective transmission reception points that is associated with the uplink channel transmissions using a respective timing advance value. The operations of 1810 may be performed in accordance with examples as disclosed herein. In some examples, aspects of the operations of 1810 may be performed by a control message component 1430 as described with reference to FIG. 14.

At 1815, the method may include determining a first timing advance value for the uplink channel transmissions to the first transmission reception point of the one or more respective transmission reception points based on the one or more respective timing advance indications identifying the respective transmission reception point of the one or more respective transmission reception points. The operations of 1815 may be performed in accordance with examples as disclosed herein. In some examples, aspects of the operations of 1815 may be performed by a timing advance value component 1435 as described with reference to FIG. 14.

At 1820, the method may include receiving an uplink channel transmission over an uplink channel using the first timing advance value determined for the first transmission reception point. The operations of 1820 may be performed in accordance with examples as disclosed herein. In some examples, aspects of the operations of 1820 may be performed by an uplink transmission component 1440 as described with reference to FIG. 14.

FIG. 19 shows a flowchart illustrating a method 1900 that supports a timing advance command for downlink control information for transmission reception point operation in accordance with aspects of the present disclosure. The operations of the method 1900 may be implemented by a network entity or its components as described herein. For example, the operations of the method 1900 may be performed by a network entity as described with reference to FIGS. 1 through 7 and 12 through 15. In some examples, a network entity may execute a set of instructions to control the functional elements of the network entity to perform the described functions. Additionally or alternatively, the network entity may perform aspects of the described functions using special-purpose hardware.

At 1905, the method may include establishing communication with a UE. The operations of 1905 may be performed in accordance with examples as disclosed herein. In some examples, aspects of the operations of 1905 may be performed by a communication establishment component 1425 as described with reference to FIG. 14.

At 1910, the method may include transmitting a single control message including one or more respective timing advance indications for uplink channel transmissions to one or more respective transmission reception points of a set of multiple transmission reception points including a first transmission reception point and a second transmission reception point, each timing advance indication of the one or more respective timing advance indications identifying a respective transmission reception point of the one or more respective transmission reception points that is associated with the uplink channel transmissions using a respective timing advance value. The operations of 1910 may be performed in accordance with examples as disclosed herein. In some examples, aspects of the operations of 1910 may be performed by a control message component 1430 as described with reference to FIG. 14.

At 1915, the method may include transmitting a second control message including a timing advance command indication corresponding to the first transmission reception point of the one or more respective transmission reception points. The operations of 1915 may be performed in accordance with examples as disclosed herein. In some examples, aspects of the operations of 1915 may be performed by a control message component 1430 as described with reference to FIG. 14.

At 1920, the method may include including a timing advance group identifier indicating the first transmission reception point in the second control message, where receiving the uplink channel transmission is based on including the timing advance group identifier in the second control message. The operations of 1920 may be performed in accordance with examples as disclosed herein. In some examples, aspects of the operations of 1920 may be performed by a timing advance value component 1435 as described with reference to FIG. 14.

At 1925, the method may include determining a first timing advance value for the uplink channel transmissions to the first transmission reception point of the one or more respective transmission reception points based on the one or more respective timing advance indications identifying the respective transmission reception point of the one or more respective transmission reception points. The operations of 1925 may be performed in accordance with examples as disclosed herein. In some examples, aspects of the operations of 1925 may be performed by a timing advance value component 1435 as described with reference to FIG. 14.

At 1930, the method may include receiving an uplink channel transmission over an uplink channel using the first timing advance value determined for the first transmission reception point. The operations of 1930 may be performed in accordance with examples as disclosed herein. In some examples, aspects of the operations of 1930 may be performed by an uplink transmission component 1440 as described with reference to FIG. 14.

The following provides an overview of aspects of the present disclosure:

Aspect 1: A method for wireless communication at a UE, comprising: establishing communication with a plurality of transmission reception points comprising a first transmission reception point and a second transmission reception point; receiving a single control message comprising one or more respective timing advance indications for uplink channel transmissions to one or more respective transmission reception points of the plurality of transmission reception points, each timing advance indication of the one or more respective timing advance indications identifying a respective transmission reception point of the one or more respective transmission reception points that is associated with the uplink channel transmissions using a respective timing advance value; determining a first timing advance value for the uplink channel transmissions to the first transmission reception point of the one or more respective transmission reception points based at least in part on the one or more respective timing advance indications identifying the respective transmission reception point of the one or more respective transmission reception points; and transmitting, to the first transmission reception point of the one or more respective transmission reception points, an uplink channel transmission over an uplink channel using the first timing advance value determined for the first transmission reception point.

Aspect 2: The method of aspect 1, wherein receiving the single control message comprising the one or more respective timing advance indications further comprises: receiving a first control message comprising a first timing advance command indication corresponding to the first transmission reception point of the one or more respective transmission reception points; and receiving a second control message comprising a second timing advance command indication corresponding to the second transmission reception point of the one or more respective transmission reception points.

Aspect 3: The method of aspect 2, further comprising: determining the first transmission reception point based at least in part on a first timing advance group identifier included in the first control message; and determining the second transmission reception point based at least in part on a second timing advance group identifier included in the second control message, wherein transmitting the uplink channel transmission is based at least in part on determining the first transmission reception point and the second transmission reception point.

Aspect 4: The method of aspect 3, further comprising: receiving a control signaling indicating a mapping between a plurality of timing advance group identifiers and the plurality of transmission reception points, wherein the plurality of timing advance group identifiers comprises the first timing advance group identifier and the second timing advance group identifier, and wherein transmitting the uplink channel transmission is based at least in part on receiving the control signaling indicating the mapping.

Aspect 5: The method of any of aspects 2 through 4, further comprising: determining the first transmission reception point based at least in part on a first transmission reception point identifier included in the first control message; and determining the second transmission reception point based at least in part on a second transmission reception point identifier included in the second control message, wherein transmitting the uplink channel transmission is based at least in part on determining the first transmission reception point and the second transmission reception point.

Aspect 6: The method of any of aspects 2 through 5, further comprising: determining that the first timing advance command indication and the second timing advance command indication are associated with a common timing advance group identifier, wherein transmitting the uplink channel transmission is based at least in part on determining that the first timing advance command indication and the second timing advance command indication are associated with the common timing advance group identifier.

Aspect 7: The method of any of aspects 1 through 6, wherein receiving the single control message comprising the one or more respective timing advance indications further comprises: receiving the single control message comprising the first timing advance value corresponding to the first transmission reception point and a second respective timing advance value corresponding to the second transmission reception point.

Aspect 8: The method of any of aspects 1 through 7, further comprising: receiving a second control message comprising a timing advance group identifier and a reference timing advance value associated with the timing advance group identifier, wherein determining the first timing advance value for the uplink channel transmissions to the first transmission reception point is based at least in part on receiving the second control message.

Aspect 9: The method of aspect 8, further comprising: refraining from accumulating the one or more respective timing advance indications, wherein determining the first timing advance value for the uplink channel transmissions to the first transmission reception point is based at least in part on refraining from accumulating the one or more respective timing advance indications.

Aspect 10: The method of any of aspects 8 through 9, further comprising: accumulating the one or more respective timing advance indications, wherein determining the first timing advance value for the uplink channel transmissions to the first transmission reception point is based at least in part on accumulating the one or more respective timing advance indications.

Aspect 11: The method of any of aspects 1 through 10, wherein the single control message comprises a medium access control layer control element.

Aspect 12: The method of any of aspects 1 through 11, wherein the single control message comprises a medium access control layer control element.

Aspect 13: A method for wireless communication at a network entity, comprising: establishing communication with a UE; transmitting a single control message comprising one or more respective timing advance indications for uplink channel transmissions to one or more respective transmission reception points of a plurality of transmission reception points comprising a first transmission reception point and a second transmission reception point, each timing advance indication of the one or more respective timing advance indications identifying a respective transmission reception point of the one or more respective transmission reception points that is associated with the uplink channel transmissions using a respective timing advance value; determining a first timing advance value for the uplink channel transmissions to the first transmission reception point of the one or more respective transmission reception points based at least in part on the one or more respective timing advance indications identifying the respective transmission reception point of the one or more respective transmission reception points; and receiving an uplink channel transmission over an uplink channel using the first timing advance value determined for the first transmission reception point.

Aspect 14: The method of aspect 13, wherein transmitting the single control message comprising the one or more respective timing advance indications further comprises: transmitting a second control message comprising a timing advance command indication corresponding to the first transmission reception point of the one or more respective transmission reception points.

Aspect 15: The method of aspect 14, wherein transmitting the second control message comprises: including a timing advance group identifier indicating the first transmission reception point in the second control message, wherein receiving the uplink channel transmission is based at least in part on including the timing advance group identifier in the second control message.

Aspect 16: The method of aspect 15, further comprising: transmitting a control signaling indicating a mapping between a plurality of timing advance group identifiers and the plurality of transmission reception points, wherein the plurality of timing advance group identifiers comprises the timing advance group identifier, and wherein receiving the uplink channel transmission is based at least in part on transmitting the control signaling indicating the mapping.

Aspect 17: The method of any of aspects 14 through 16, wherein transmitting the second control message comprises: including a transmission reception point identifier indicating the first transmission reception point in the second control message, wherein receiving the uplink channel transmission is based at least in part on including the transmission reception point identifier in the second control message.

Aspect 18: The method of any of aspects 13 through 17, wherein transmitting the single control message comprising the one or more respective timing advance indications further comprises: transmitting the single control message comprising the first timing advance value corresponding to the first transmission reception point and a second respective timing advance value corresponding to the second transmission reception point.

Aspect 19: The method of any of aspects 13 through 18, further comprising: transmitting a second control message comprising a timing advance group identifier and a reference timing advance value associated with the timing advance group identifier, wherein determining the first timing advance value for the uplink channel transmissions to the first transmission reception point is based at least in part on transmitting the second control message.

Aspect 20: An apparatus for wireless communication at a UE, comprising a processor; memory coupled with the processor; and instructions stored in the memory and executable by the processor to cause the apparatus to perform a method of any of aspects 1 through 12.

Aspect 21: An apparatus for wireless communication at a UE, comprising at least one means for performing a method of any of aspects 1 through 12.

Aspect 22: A non-transitory computer-readable medium storing code for wireless communication at a UE, the code comprising instructions executable by a processor to perform a method of any of aspects 1 through 12.

Aspect 23: An apparatus for wireless communication at a network entity, comprising a processor; memory coupled with the processor; and instructions stored in the memory and executable by the processor to cause the apparatus to perform a method of any of aspects 13 through 19.

Aspect 24: An apparatus for wireless communication at a network entity, comprising at least one means for performing a method of any of aspects 13 through 19.

Aspect 25: A non-transitory computer-readable medium storing code for wireless communication at a network entity, the code comprising instructions executable by a processor to perform a method of any of aspects 13 through 19.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
establishing communication with a plurality of transmission reception points comprising a first transmission reception point and a second transmission reception point:
receiving a single control message comprising one or more respective timing advance indications for uplink channel transmissions to one or more respective transmission reception points of the plurality of transmission reception points, each timing advance indication of the one or more respective timing advance indications identifying a respective transmission reception point of the one or more respective transmission reception points that is associated with the uplink channel transmissions using a respective timing advance value;
determining a first timing advance value for the uplink channel transmissions to the first transmission reception point of the one or more respective transmission reception points based at least in part on the one or more respective timing advance indications identifying the respective transmission reception point of the one or more respective transmission reception points; and
transmitting, to the first transmission reception point of the one or more respective transmission reception points, an uplink channel transmission over an uplink channel using the first timing advance value determined for the first transmission reception point.

2. The method of claim 1, wherein receiving the single control message comprising the one or more respective timing advance indications further comprises:
receiving a first control message comprising a first timing advance command indication corresponding to the first transmission reception point of the one or more respective transmission reception points; and
receiving a second control message comprising a second timing advance command indication corresponding to the second transmission reception point of the one or more respective transmission reception points.

3. The method of claim 2, further comprising:
determining the first transmission reception point based at least in part on a first timing advance group identifier included in the first control message; and
determining the second transmission reception point based at least in part on a second timing advance group identifier included in the second control message, wherein transmitting the uplink channel transmission is based at least in part on determining the first transmission reception point and the second transmission reception point.

4. The method of claim 3, further comprising:
receiving a control signaling indicating a mapping between a plurality of timing advance group identifiers and the plurality of transmission reception points, wherein the plurality of timing advance group identifiers comprises the first timing advance group identifier and the second timing advance group identifier, and wherein transmitting the uplink channel transmission is based at least in part on receiving the control signaling indicating the mapping.

5. The method of claim 2, further comprising:
determining the first transmission reception point based at least in part on a first transmission reception point identifier included in the first control message; and
determining the second transmission reception point based at least in part on a second transmission reception point identifier included in the second control message, wherein transmitting the uplink channel transmission is based at least in part on determining the first transmission reception point and the second transmission reception point.

6. The method of claim 2, further comprising:
determining that the first timing advance command indication and the second timing advance command indication are associated with a common timing advance group identifier, wherein transmitting the uplink channel transmission is based at least in part on determining that the first timing advance command indication and the second timing advance command indication are associated with the common timing advance group identifier.

7. The method of claim 1, wherein receiving the single control message comprising the one or more respective timing advance indications further comprises:
receiving the single control message comprising the first timing advance value corresponding to the first transmission reception point and a second respective timing advance value corresponding to the second transmission reception point.

8. The method of claim 1, further comprising:
receiving a second control message comprising a timing advance group identifier and a reference timing advance value associated with the timing advance group identifier, wherein determining the first timing advance value for the uplink channel transmissions to the first transmission reception point is based at least in part on receiving the second control message.

9. The method of claim 8, further comprising:
refraining from accumulating the one or more respective timing advance indications, wherein determining the first timing advance value for the uplink channel transmissions to the first transmission reception point is based at least in part on refraining from accumulating the one or more respective timing advance indications.

10. The method of claim 8, further comprising:
accumulating the one or more respective timing advance indications, wherein determining the first timing advance value for the uplink channel transmissions to the first transmission reception point is based at least in part on accumulating the one or more respective timing advance indications.

11. The method of claim 1, wherein the single control message comprises a medium access control layer control element.

12. The method of claim 1, wherein the single control message comprises a medium access control layer control element.

13. A method for wireless communication at a network entity, comprising:
establishing communication with a user equipment (UE);
transmitting a single control message comprising one or more respective timing advance indications for uplink channel transmissions to one or more respective transmission reception points of a plurality of transmission reception points comprising a first transmission reception point and a second transmission reception point, each timing advance indication of the one or more respective timing advance indications identifying a respective transmission reception point of the one or more respective transmission reception points that is associated with the uplink channel transmissions using a respective timing advance value;
determining a first timing advance value for the uplink channel transmissions to the first transmission reception point of the one or more respective transmission reception points based at least in part on the one or more respective timing advance indications identifying the respective transmission reception point of the one or more respective transmission reception points; and
receiving an uplink channel transmission over an uplink channel using the first timing advance value determined for the first transmission reception point.

14. The method of claim 13, wherein transmitting the single control message comprising the one or more respective timing advance indications further comprises:
transmitting a second control message comprising a timing advance command indication corresponding to the first transmission reception point of the one or more respective transmission reception points.

15. The method of claim 14, wherein transmitting the second control message comprises:
including a timing advance group identifier indicating the first transmission reception point in the second control message, wherein receiving the uplink channel transmission is based at least in part on including the timing advance group identifier in the second control message.

16. The method of claim 15, further comprising:
transmitting a control signaling indicating a mapping between a plurality of timing advance group identifiers and the plurality of transmission reception points, wherein the plurality of timing advance group identifiers comprises the timing advance group identifier, and wherein receiving the uplink channel transmission is based at least in part on transmitting the control signaling indicating the mapping.

17. The method of claim 14, wherein transmitting the second control message comprises:
including a transmission reception point identifier indicating the first transmission reception point in the second control message, wherein receiving the uplink channel transmission is based at least in part on including the transmission reception point identifier in the second control message.

18. The method of claim 13, wherein transmitting the single control message comprising the one or more respective timing advance indications further comprises:
transmitting the single control message comprising the first timing advance value corresponding to the first transmission reception point and a second respective timing advance value corresponding to the second transmission reception point.

19. The method of claim 13, further comprising:
transmitting a second control message comprising a timing advance group identifier and a reference timing advance value associated with the timing advance group identifier, wherein determining the first timing advance value for the uplink channel transmissions to the first transmission reception point is based at least in part on transmitting the second control message.

20. An apparatus for wireless communication at a user equipment (UE), comprising:
a processor;
memory coupled with the processor; and
instructions stored in the memory and executable by the processor to cause the apparatus to:
establish communication with a plurality of transmission reception points comprising a first transmission reception point and a second transmission reception point;
receive a single control message comprising one or more respective timing advance indications for uplink channel transmissions to one or more respective transmission reception points of the plurality of transmission reception points, each timing advance indication of the one or more respective timing advance indications identifying a respective transmission reception point of the one or more respective transmission reception points that is associated with the uplink channel transmissions using a respective timing advance value;
determine a first timing advance value for the uplink channel transmissions to the first transmission reception point of the one or more respective transmission reception points based at least in part on the one or more respective timing advance indications identifying the respective transmission reception point of the one or more respective transmission reception points; and
transmit, to the first transmission reception point of the one or more respective transmission reception points, an uplink channel transmission over an uplink channel using the first timing advance value determined for the first transmission reception point.

21. The apparatus of claim 20, wherein the instructions to receive the single control message comprising the one or more respective timing advance indications are further executable by the processor to cause the apparatus to:
receive a first control message comprising a first timing advance command indication corresponding to the first transmission reception point of the one or more respective transmission reception points; and
receive a second control message comprising a second timing advance command indication corresponding to the second transmission reception point of the one or more respective transmission reception points.

22. The apparatus of claim 21, wherein the instructions are further executable by the processor to cause the apparatus to:
determine the first transmission reception point based at least in part on a first timing advance group identifier included in the first control message; and
determine the second transmission reception point based at least in part on a second timing advance group identifier included in the second control message, wherein transmitting the uplink channel transmission is based at least in part on determining the first transmission reception point and the second transmission reception point.

23. The apparatus of claim 22, wherein the instructions are further executable by the processor to cause the apparatus to:
receive a control signaling indicating a mapping between a plurality of timing advance group identifiers and the plurality of transmission reception points, wherein the plurality of timing advance group identifiers comprises the first timing advance group identifier and the second timing advance group identifier, and wherein transmitting the uplink channel transmission is based at least in part on receiving the control signaling indicating the mapping.

24. The apparatus of claim 21, wherein the instructions are further executable by the processor to cause the apparatus to:
determine the first transmission reception point based at least in part on a first transmission reception point identifier included in the first control message; and
determine the second transmission reception point based at least in part on a second transmission reception point identifier included in the second control message, wherein transmitting the uplink channel transmission is based at least in part on determining the first transmission reception point and the second transmission reception point.

25. The apparatus of claim 21, wherein the instructions are further executable by the processor to cause the apparatus to:
determine that the first timing advance command indication and the second timing advance command indication are associated with a common timing advance group identifier, wherein transmitting the uplink channel transmission is based at least in part on determining that the first timing advance command indication and the second timing advance command indication are associated with the common timing advance group identifier.

26. The apparatus of claim 20, wherein the instructions to receive the single control message comprising the one or more respective timing advance indications are further executable by the processor to cause the apparatus to:
receive the single control message comprising the first timing advance value corresponding to the first transmission reception point and a second respective timing advance value corresponding to the second transmission reception point.

27. The apparatus of claim 20, wherein the instructions are further executable by the processor to cause the apparatus to:
receive a second control message comprising a timing advance group identifier and a reference timing advance value associated with the timing advance group identifier, wherein determining the first timing advance value for the uplink channel transmissions to the first transmission reception point is based at least in part on receiving the second control message.

28. The apparatus of claim 27, wherein the instructions are further executable by the processor to cause the apparatus to:
refrain from accumulating the one or more respective timing advance indications, wherein determining the first timing advance value for the uplink channel transmissions to the first transmission reception point is based at least in part on refraining from accumulating the one or more respective timing advance indications.

29. The apparatus of claim 27, wherein the instructions are further executable by the processor to cause the apparatus to:
accumulate the one or more respective timing advance indications, wherein determining the first timing advance value for the uplink channel transmissions to the first transmission reception point is based at least in part on accumulating the one or more respective timing advance indications.

30. An apparatus for wireless communication at a network entity, comprising:
a processor;
memory coupled with the processor; and
instructions stored in the memory and executable by the processor to cause the apparatus to:
establish communication with a user equipment (UE);
transmit a single control message comprising one or more respective timing advance indications for uplink channel transmissions to one or more respective transmission reception points of a plurality of transmission reception points comprising a first transmission reception point and a second transmission reception point, each timing advance indication of the one or more respective timing advance indications identifying a respective transmission reception point of the one or more respective transmission reception points that is associated with the uplink channel transmissions using a respective timing advance value;
determine a first timing advance value for the uplink channel transmissions to the first transmission reception point of the one or more respective transmission reception points based at least in part on the one or more respective timing advance indications identifying the respective transmission reception point of the one or more respective transmission reception points; and
receive an uplink channel transmission over an uplink channel using the first timing advance value determined for the first transmission reception point.
